(19) United States
(12) Patent Application Publication
(10) Pub. No.: US 2004/0017456 A1
(43) Pub. Date: Jan. 29, 2004

(54) Ink jet printing device

(76) Inventors: Franz Obertegger, Brixen (IT); Mario Gandini, Brixen (IT)

Correspondence Address: WILLIAM COLLARD, COLLARD & ROE, P.C., 1077 NORTHERN BOULEVARD, ROSLYN, NY, 11576, US

(21) Appl. No.: 10/380,656

(22) PCT Filed: Sep. 17, 2001
(86) PCT No.: PCT/EP01/10732

(30) Foreign Application Priority Data
Sep. 15, 2000 (IT) BZ2000A000037

(51) Int. Cl. B41J 2/01

(52) U.S. Cl. 347/104

(57) ABSTRACT

The invention relates to an ink jet printer (10) for different media with a print head unit (14) having at least one print head (16) for applying print to the medium (101) and a printing table (110) for positioning and/or guiding the medium (101) to be printed, and a displacement mechanism for varying a distance between the print head unit (14) and the medium (101) in a direction perpendicular to the guide surface as well as a control system (120). A base element (12) and/or a printing table (110) is disposed on a machine frame (11) and one of the two constituting a support or guide surface (130) for a medium (101) are in one plane and a feed system is provided on the printing table (110) and/or base element(12) to feed through a virtually inherently stiff medium (101), and a print head unit (14) can be displaced by means of a displacement drive along a transverse guide track disposed on the machine frame (11) extending parallel with the plane and transversely to the feed direction (137) and incorporates several nozzles (114) for applying inks, the outlet orifices (138) of which are distributed in a same plane (139) parallel with the plane.

The invention relates to an ink jet printer for media, of the type outlined in the generic part of claims 1 and 32, and a method of applying print to media, of the type outlined in the generic part of claims 70 and 73.

A plurality of ink jet printers are known—U.S. Pat. No. 6,092,890 A, EP 0 842 051 B1, DE 4 019 543 A, DE 3 417 375 A—which have proved suitable for a whole variety of applications. Accordingly, ink jet printers may be used for applying print to different media, such as paper and plastic films, which in particular might also be of differing absorption capacity and porosity. Each of these media requires a different approach. It has therefore been something of a draw-back that devices of this type have been suitable for one specific medium only.

The underlying objective of the invention is to propose an ink jet printer which can be used flexibly for a whole variety of media. Furthermore, the ink jet printer should require very little in the way of adjustments in order to adapt it to another printing medium with different properties.

This objective is achieved by the invention due to the ink jet printer defined in claim 1. The advantage of this approach is that an ink jet printer can now be used to print directly onto board-type media that are essentially inherently stiff, such as corrugated board or sheets of corrugated board, boards of card which can not be processed from the roll, plywood, composite boards, plastics boards and metal boards. For the first time, it is therefore possible to produce machines which can be used for printing directly onto the most varied of materials, such as paper, fabrics, cardboard and metal.

The embodiment defined in claim 2 is of advantage because it enables media of different thicknesses to be processed.

Claim 3 defines another advantageous embodiment because it enables inherently stiff media to be guided perfectly, even if the length of the medium is longer than the short length of the support surface or guide surface in the region of the ink jet printer.

Another possible embodiment is defined in claim 4, whereby, again, even if the length of the support surface or guide surface in the region of the ink jet printer is relatively short compared with the length of the medium, bending is prevented when working with inherently stiff media.

Claim 5 defines another practical embodiment which prevents damage to the printer or faulty printing.

Also of advantage are the embodiments defined in claims 6 to 10, since they enable inherently stiff media to be laterally positioned easily and exactly and absorb the lateral guide pressure.

Another advantage is obtained by the embodiment of an ink jet printer defined in claim 11, since it can be adjusted in a simple manner for handling different media, such as fabrics, paper webs, cardboard sheets or plastics elements.

A sensitive control of the forward feed and/or orientation of the medium is obtained by the embodiment defined in claim 12.

The embodiment defined in claim 13 permits sensitive handling of the medium to be printed because the rolls can be adjusted to a plurality of settings to suit the nature and consistency of the medium, such as inherently stiff materials or floppy materials. The embodiments defined in claims 14 and 15 enable the medium being printed to be accurately guide and smoothed flat.

Also of advantage is the embodiment defined in claim 16, because it ensures that a uniform feed rate can be obtained over a broader range. Forward feed is also possible without the need for pressure rolls, thereby also enabling pressure-sensitive and very flexible and sensitive materials to be processed.

The medium can be perfectly adjusted in height in the region of a belt feed as a result of the embodiments defined in claims 17 to 22.

Claim 23 defines an advantageous embodiment which enables the length of an intermittent forward feed motion to be controlled exactly by displacing the dancer roll.

Also of advantage is another embodiment described in claims 24 and 25, since it permits the use of a device for absorbing excess ink on the support surface for the medium as and when needed.

Other embodiments described in claims 26 to 29 are of advantage because they also enable board-type elements made from different materials, such as cardboard and plastics, to be processed in ink jet printers designed for processing flexible media.

The other embodiments defined in claims 30 and 31 are of advantage because they enable media to be processed which need not necessarily overlap with the entire guide surface in the feed direction at their beginning and/or end.

The objective of the invention is also achieved, preferably independently, by the features set out in claim 32. Accordingly, the ink jet printer proposed by the invention is distinctive because it enables print to be applied to media fed from rolls as well as sheets, either flexible or stiff, impermeable or porous media, since the distance between the medium and the print head unit or print head and the respective nozzle for every colour to be adapted individually to suit pre-definable conditions. In other words, the print head or print heads and nozzles can be mounted relative to a printing table or its support surface and the top face of the media so that it can be flexibly adjusted in terms of the distance from the printing table and hence from the medium to be printed and/or the lateral orientation of the medium. As a result, the ink jet printer proposed by the invention can be used to apply print to media of different thicknesses. As a result of this feature, the ink jet printer proposed by the invention is also suitable for printing media with different properties in different ways, in particular to provide a guiding action across the printing table at a height adjusted to suit the properties of the medium and in a reliable and constant manner.

As a result of the preferred embodiment defined in claim 33, the printer can be readily adjusted on a fully automated basis to cater for different thicknesses of media, and before the printing process is initiated, it can be ascertained whether the thickness of the medium to be introduced matches the pre-set value in order to prevent incorrect printing which could cause damage to the printing device. The embodiments defined in claims 34 to 37 improve the avoidance of errors still further when different media are introduced.

Claim 38 defines an advantageous embodiment which enables the desired distance to be adequately monitored throughout the entire printing process and either interrupts the print run or applies corrective measures in the event of variances.

The embodiment defined in claim 39 ensures that a pre-selected distance set with a view to achieving optimum printing results can be exactly maintained, irrespective of any movement and deformation of the medium, so that a corresponding print quality can be produced even on a medium that is slightly deformed or has parts that do not lie flat.

Advantage is to be had from an embodiment defined in claim 40 since it enables rapid resetting or system initialisation when printing different media.

Also of advantage is an embodiment defined in claim 41, since it enables every nozzle of a print head and a print head unit to be controlled with pinpoint accuracy, thereby rendering it possible to make allowance for various adjustments depending on the physical behaviour of the respective colour used in terms of consistency and viscosity.

The embodiment defined in claim 42 ensures that print will be applied uniformly to a medium forming a flat surface.

Claim 43 defines another advantageous embodiment which enables different media to be printed on a machine of standard construction.

The advantage of the embodiment defined in claim 44 is that it enables an exact distance to be calculated or detected between the print head unit, the printing table and its support surface as well as the top face of the medium, on the basis of a single measurement taken between the print head unit and top face of the medium or by a composite measurement from the support surface or from the printing table to the surface of the medium and the distance between the printing table and the print head unit.

The print heads can be adjusted on a more individual basis to suit the surface of the medium to be printed and the printing table, in particular where there is a flat support surface for guiding the medium in the printing region, as a result of the embodiment defined in claim 45.

The nozzles can be exactly positioned and ink applied perfectly as a result of the embodiment defined in claim 46, because the distance of the individual nozzles to the surface of the medium and the printing table can be individually adjusted.

The embodiments defined in claims 47 to 49 enable the actual value for the distance to be set exactly, regardless of the medium which happens to be being printed.

Other embodiments of the design used for the distance sensor are described in claims 50 and 51 and the distance can be detected directly by different arrangements of the distance sensors, which consist of several parts, and adding the various part-measurement values or due to the co-operating parts of the distance sensor.

An advantage is also to be had from an embodiment defined in claim 52, since the sequence of motion of the nozzles of the print head or the print head unit can be determined before producing a line of print, thereby enabling more sensitive control of the sequence, especially the motion of the nozzles and the print head or print head unit.

The embodiments defined in claims 53 to 55 use an electronic computer, which enables the desired value to be changed rapidly and offers sensitive, high-precision control with an extremely rapid response capability.

Also of advantage is an embodiment defined in claim 56, since it enables the basic distance of the print head unit to be set depending on the thickness of the medium, as well as the position of the printing table—depending on whether an ink absorbing unit is to be provided underneath the medium or not.

As a result of the embodiment defined in claims 57 to 65, the individual parts of the ink jet printer can be flexibly set and adjusted in all directions. Naturally, it is also possible to provide only individual drives and guide systems, although any of the described adjusting mechanisms and guide arrangements may be used in combination with one another.

The medium can be guided exactly, even if when working with different thicknesses of medium, and various accessories may be used, such as an ink absorbing unit, as a result of the embodiment defined in claim 66.

Also of advantage is an embodiment of the type defined in claim 67, since it ensures that flexible materials or materials of the type which are not able to take any lateral guiding pressure, can be exactly positioned in the printing region of the ink jet printer. This makes it possible to work with fabrics.

Another embodiment defined in claim 68 has proved to be of advantage since it enables changes which might occur in the lateral position in the region of the printing device to be detected very early, rendering the machine capable of processing the most varied of flat media, whether they be flexible, stiff, impermeable or porous.

The objective of the invention can also be achieved, preferably independently, by the method defined in claim 70.

Accordingly, a single, stationary machine can be used for printing semi-stiff and inherently stiff media such as cardboard, plastics boards, metal boards or similar as they are continuously fed through, which means that designs of a large surface area can be cost-effectively printed, even on inherently stiff materials of varying surface quality, whether porous or non-absorbent, which eliminates the process that would otherwise be needed of producing thin adhesive films and then applying them to stiff components of this type.

An approach as defined in claim 71 is of particular advantage when processing media with significant differences in thickness since the occurrence of faulty batches and damage to the machine causing different thicknesses of media is safely avoided.

The approach defined in claim 72 enables inherently stiff media that are significantly bigger than the support and guide surface in the region of the ink jet printer to be processed.

The objective is also achieved by a preferred independent solution defined in claim 73. The advantage of this approach is that it provides a simple means of guaranteeing the print quality by monitoring the thickness.

The approach defined in claim 74 may also be used to advantage to ensure that at the start of the printing process, the ink jet printer and its nozzles are correctly positioned at the right height above the surface of the medium to be printed with a view to achieving high quality.

Claim 75 defines features which prevent any damage due to the wrong medium being introduced into the ink jet printer.

If the roll of medium shifts, the features defined in claim 76 enable an exact lateral positioning of the medium, so that media can be printed without edges, both in the longitudinal direction and in the transverse direction.

Misprints due to any undesirable lateral relative displacement between medium and print head can be avoided by the approach defined in claim 77.

Even media of different thicknesses and three-dimensional variations or changes can be printed to a high quality as a result of the approach defined in claim 78.

A uniform printed image can also be produced using media with a long length as a result of the approach defined in claim 79 and/or 80.

In order to provide an exact forward feed marker, it is recommendable to use an approach as defined in claim 81 or 82, since it reliably ensures that the formation of stripes will be avoided when producing such print on large surfaces.

The invention will be explained in more detail with reference to examples of embodiments illustrated in the appended drawings.

Of these:

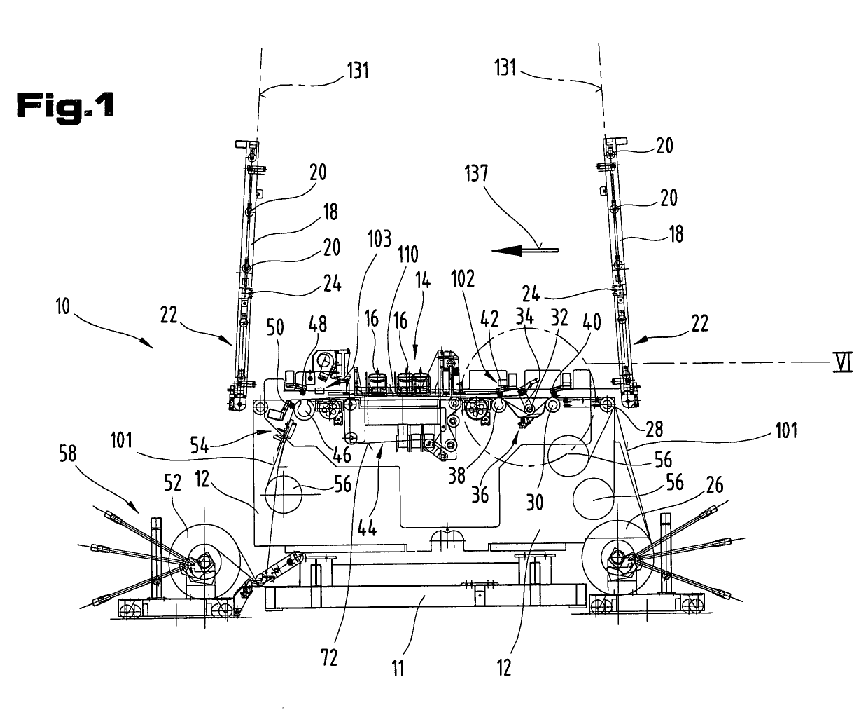

FIG. 1 is a side view of the ink jet printer proposed by the invention in the mode used to print paper fed from a roller;

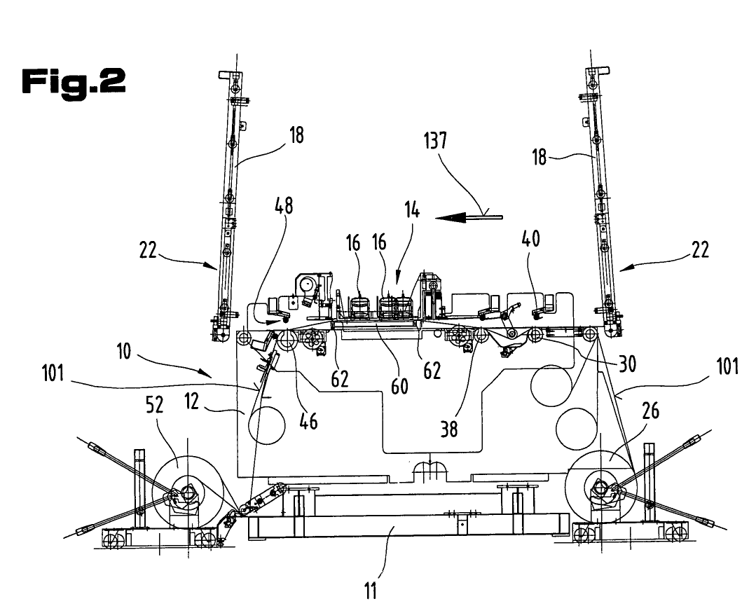

FIG. 2 is a side view of the ink jet printer proposed by the invention in the mode used to print flexible fabric from a roller;

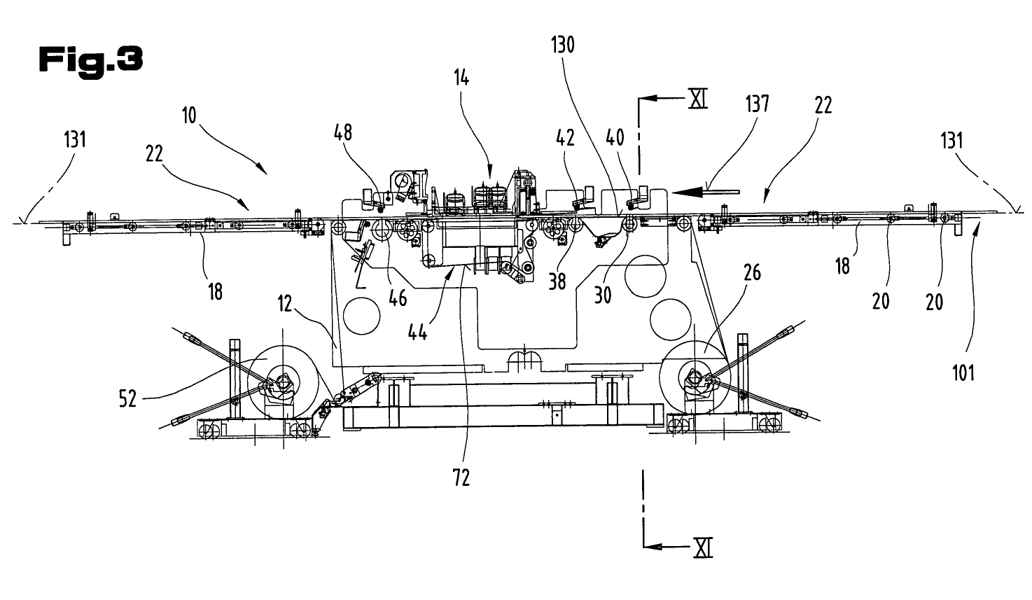

FIG. 3 is a side view of the ink jet printer proposed by the invention in the mode used to print a board-shaped medium;

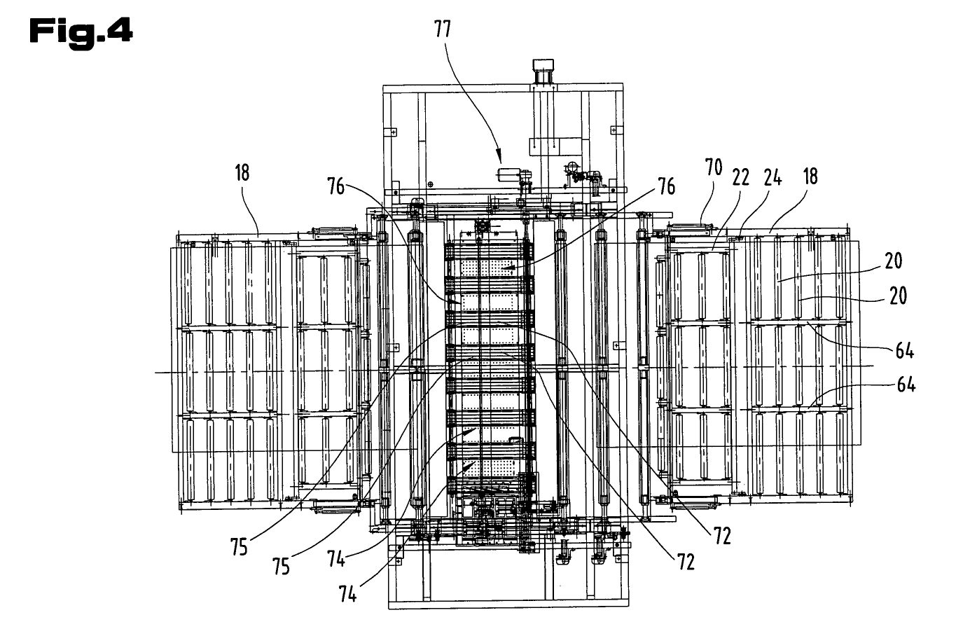

FIG. 4 is a plan view of the ink jet printer proposed by the invention;

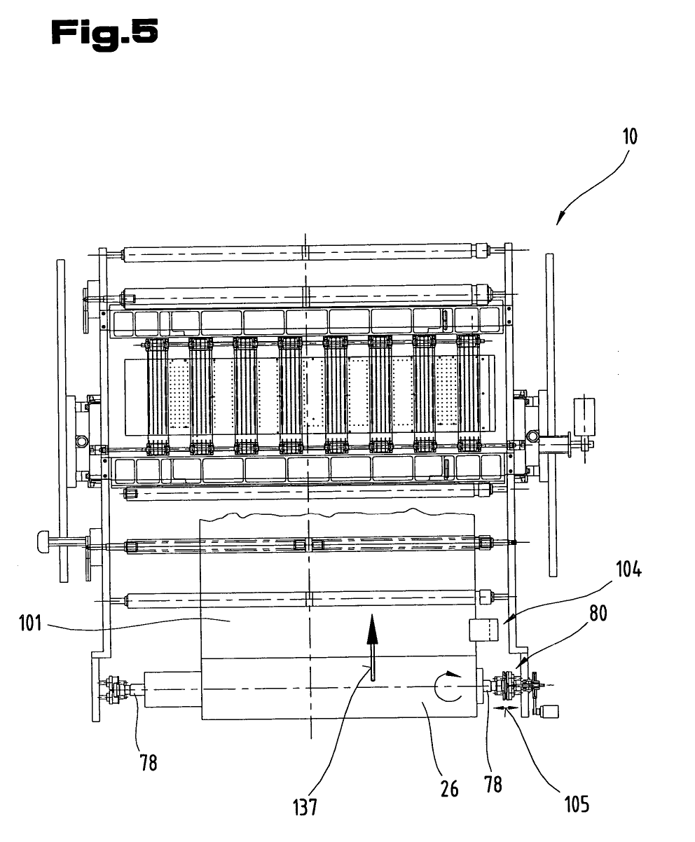

FIG. 5 is a plan view showing a section of the ink jet printer proposed by the invention.

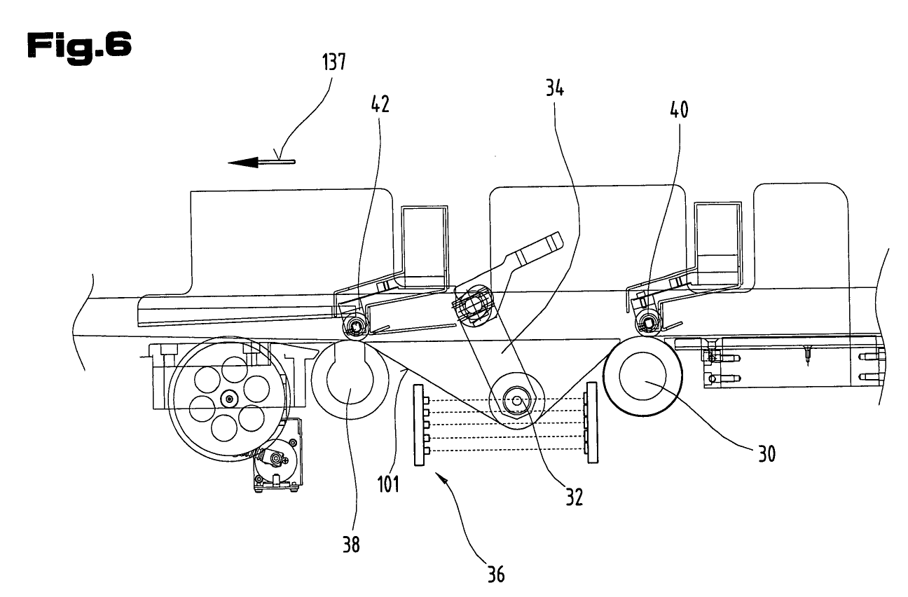

FIG. 6 is a detail of the ink jet printer with a sensor, taken from FIG. 1;

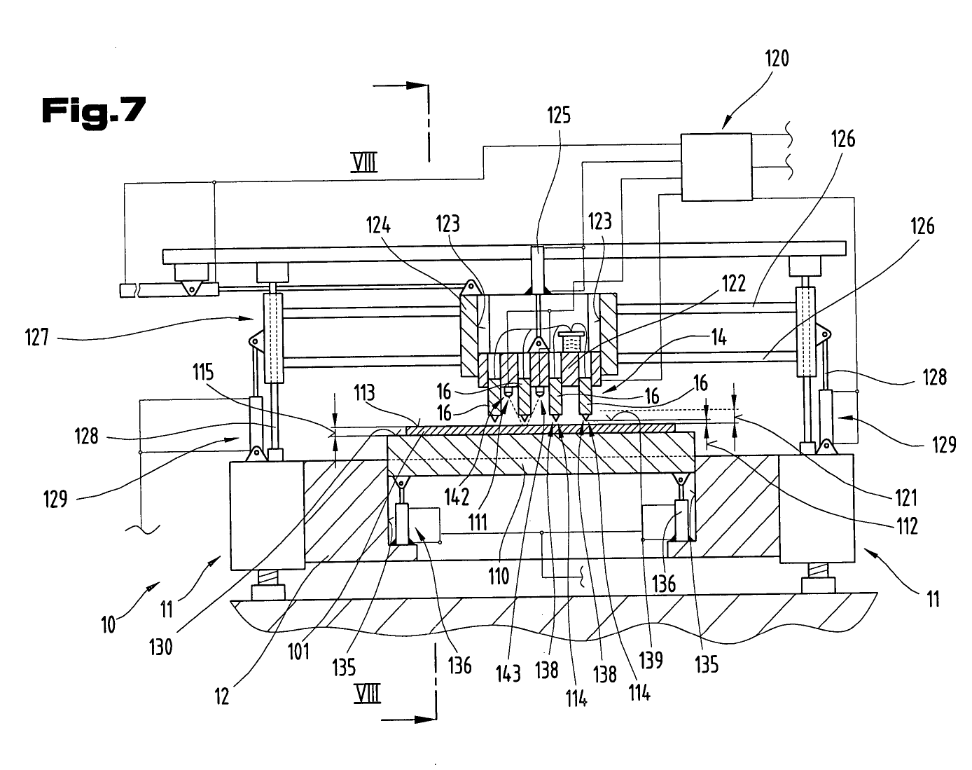

FIG. 7 is a simplified operating diagram of an ink jet printer;

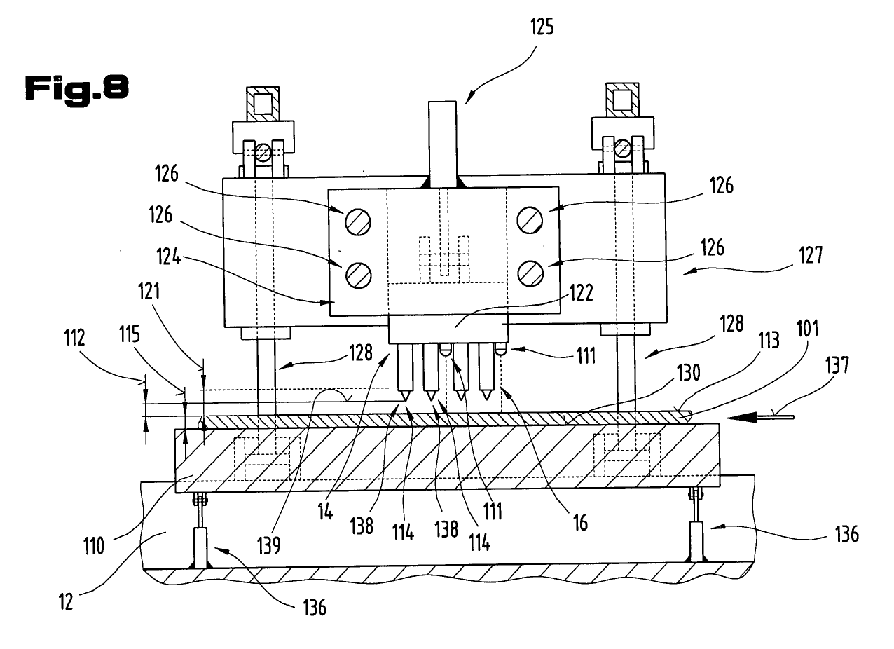

FIG. 8 is a diagram in section, showing a detail of the print head arrangement of an ink jet printer of the type illustrated in FIG. 7;

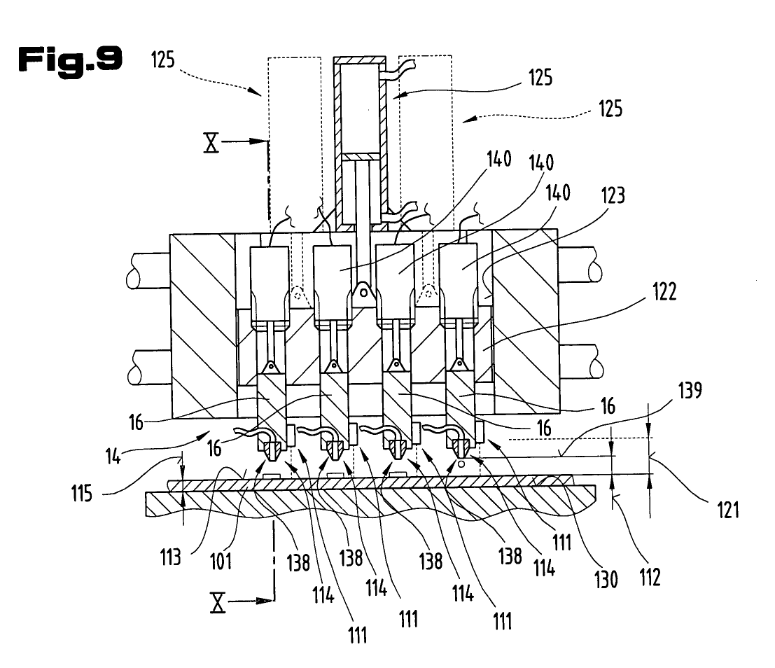

FIG. 9 is a diagram in section showing a detail of an ink jet printer with a carriage;

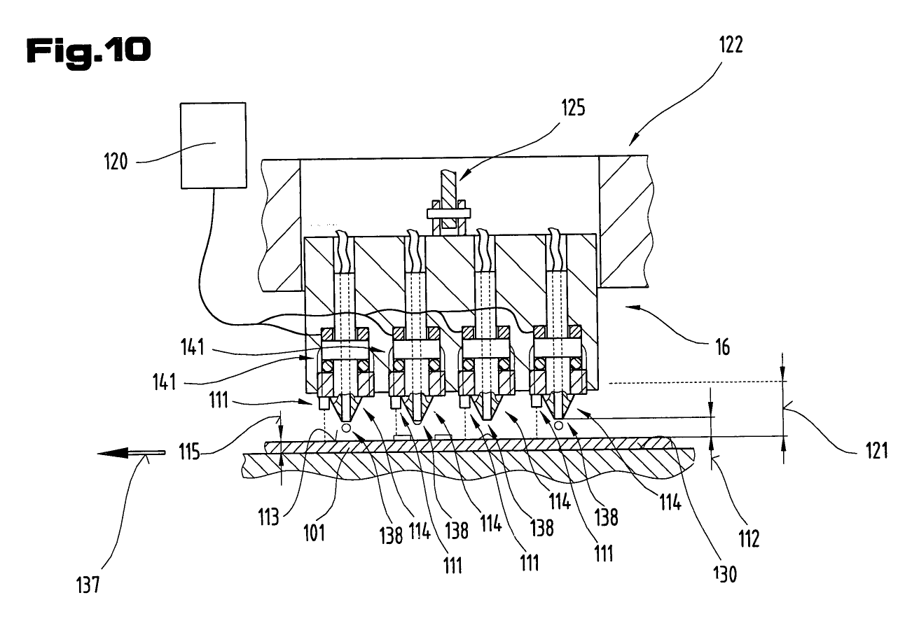

FIG. 10 is a diagram in section similar to FIG. 9 showing a detail of the print head with a mount;

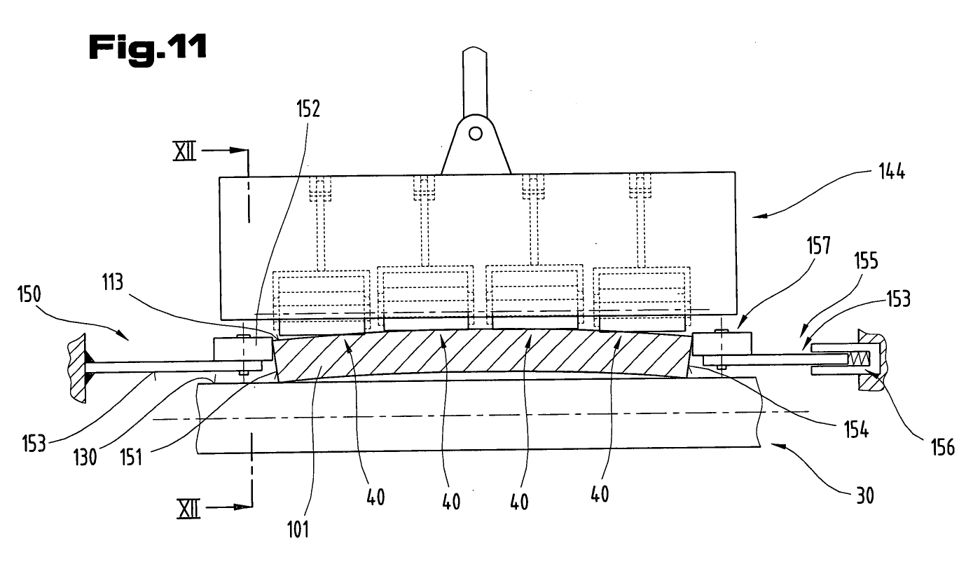

FIG. 11 is a section showing an arrangement of the feed roll, pressure roll and lateral guide tracks, as illustrated in FIG. 3;

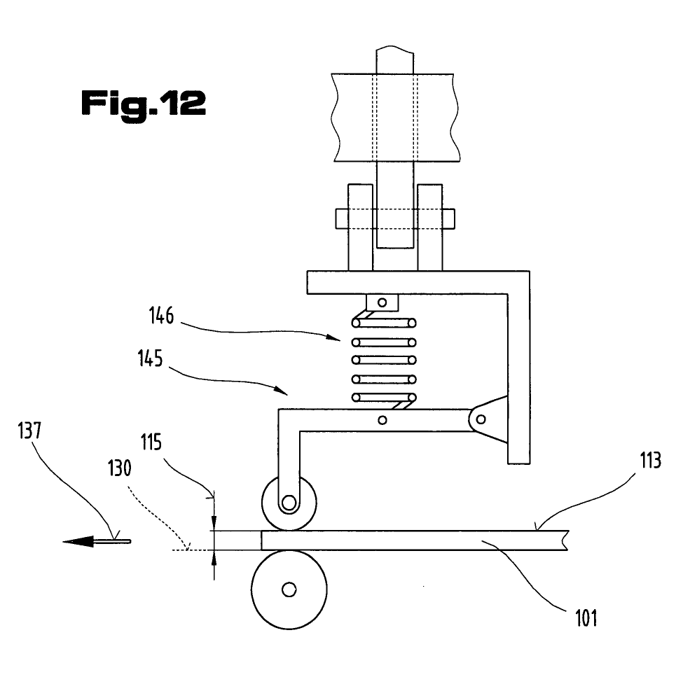

FIG. 12 is a section through an arrangement consisting of a feed roll and a pressure roll, as illustrated in FIG. 11;

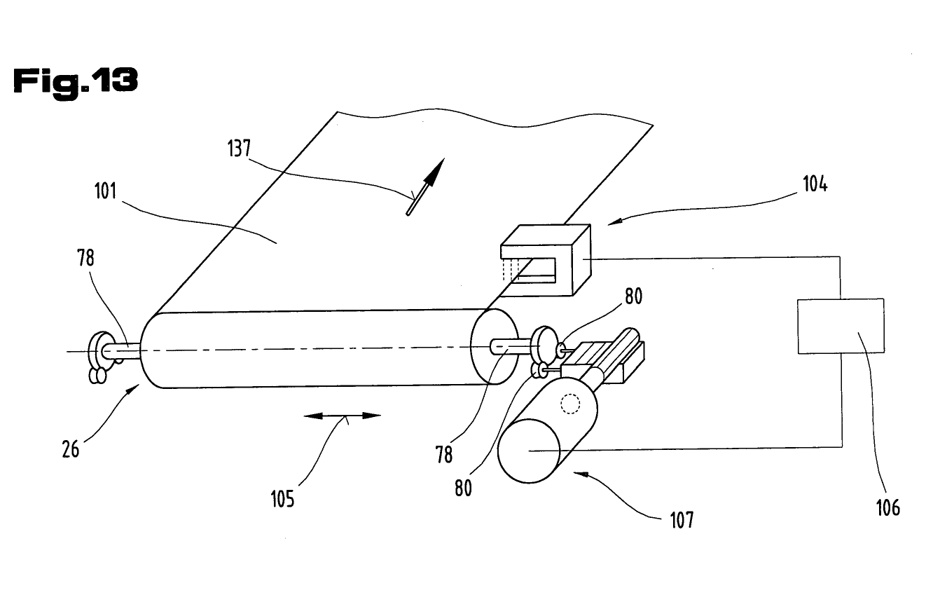

FIG. 13 is a detail of a roll mounting for a medium roller, as illustrated in FIG. 5.

As may be seen from FIG. 1, the ink jet printer 10 proposed by the invention has a base element 12 attached to a machine frame 11, on which various rolls, to be described in more detail below, are mounted. A print head unit 14 with various print heads 16 is also mounted in a frame structure on the base element 12 so that it can be raised and lowered, enabling the print heads 16 to be adjusted accordingly for printing media of differing thicknesses, for example. In the embodiment illustrated here, a fold-down table 18 is mounted both at the input end (the right-hand side in FIG. 1) and at the discharge end, which is provided with several rollers 20 forming guide elements, and additionally having a fold-down section 22 in its lower region when in the upwardly folded position, which can be folded upwards about a folding axis 24 so that opens up a sort of window in the table 18, through which the ink jet printer 10 is also accessible from the input and discharge ends. The two tables 18 are illustrated in the folded-up position in FIG. 1 since, as will be explained in more detail below, this is the mode in which a medium fed off from a roller is printed. If a sheet or board format medium is to be printed, however, as will be explained with reference to FIG. 3, the two tables 18 are swung down into a horizontal position, in which case the tables 18 might also be termed a support so that boards can be introduced without having to be handled further, especially if they are relatively heavy.

Starting with FIG. 1, an explanation will firstly be given of how the ink jet printer 10 proposed by the invention is used to print rolled media. In the bottom right-hand region of FIG. 1 is a medium roller 26, which is mounted in a roller bearing, as will be explained in more detail below. The rolled medium is fed starting from a medium roller 26 firstly via a deflector roll 28 to a feed roll 30. From the feed roll 30, the medium 101 is fed underneath a dancer roll 32, which is pivotably mounted by means of an arm 34. Disposed underneath the dancer roll 32 is a sensor 36, which co-operates with the latter in a manner that will be explained in more detail below. Downstream of the dancer roll 32 is a so-called brake roll 38, known as a brake roll 38 because it is rotated not in the feed direction but in the opposite direction when printing flexible media. In other words, as illustrated in the diagram of FIG. 1, the brake roll 38 rotates in a clockwise direction, whilst the medium 101 is moved through the ink jet printer 10 from right to left and the feed roll 30 rotates anti-clockwise.

The relative position of components of the ink jet printer 10 throughout the rest of the description are explained by reference to the feed direction of the medium 101. Accordingly, by downstream is meant the displacement of the medium 101 from the medium roller 26 via the deflector roll 28, the feed roll 30, the dancer roll 32, the brake roll 38 and finally underneath the print heads 16, followed by the remaining displacement via the conveyor roll 46 to the roller 56 and discharge mechanism 58, this direction also being referred to as the feed direction 137. By contrast, the motion in the opposition direction and accordingly associated three-dimensional aspects of the layout of parts of the ink jet printer 10, are described on the basis of the upstream direction.

Similarly, the end of the ink jet printer 10 at which the medium roller 26 is disposed is referred to as the media input end or input end and the end of the ink jet printer 10 lying opposite the medium roller 26 is referred to as the media discharge end or discharge end.

To impart versatility to the ink jet printer 10 proposed by the invention in the various applications for which it can be used, it has proved to be of advantage to combine at least one roll, e.g. the feed roll 30, the brake roll 38 or the conveyor roll 46 with a pressure roll which can be moved into and out of engagement. The pressure roll may co-operate with the associated roll as a conveyor or feed roll. This is necessary when working with particularly heavy media in board format, which can not be conveyed by a belt drive without taking extra steps, as will be described in more detail with reference to FIG. 4. When conveying media of this type, the pressure roll may therefore be brought into engagement with a roll which might be described as a conveyor roll, which will provide the requisite transport. In situations where the forward feed can be effected in a different way because a different medium 101 is to be processed, the pressure roll is then disengaged, for example pivoted into an appropriate position.

In the present instance, a pivotably mounted pressure roll 40 respectively 42 is provided both above the feed roll 30 and above the brake roll 38, at the point where contact is made with the medium 101. Consequently, the paper is tautened in the region of the dancer roll 32. The fact that the various rolls can be used with such flexibility means that various requirements can be met depending on the different types of medium to be printed. For example, operating a feed roll 30 in different ways enables the various requirements inherent in printing a flexible medium 101 to be met as best possible, as opposed to a relatively stiff one.

With the ink jet printer 10 proposed by the invention, for example, it is possible to use a separately controllable roll as a feed roll 30 for printing paper that is relatively less flexible as a means of moving the paper forwards by a defined feed length at specific instants.

If, on the other hand, a flexible medium 101 such as cotton is to be printed, the same roll, i.e. the feed roll 30 that is operated as a feed roll when printing paper is not driven but is stationary and therefore acts as a guide mechanism. As a result, the flexible fabric is drawn by a conveyor roll 46 across the stationary roll, i.e. the feed roll 30, and is always held taut or “ironed out”. In this situation, the stationary roll, i.e. the feed roll 30, may also be operated so that it is rotated by a small angle of a few minutes, for example, so that wear on the feed roll 30 caused by the material as it is pulled across it is constant around the circumference of the roll. Accordingly, because the invention proposes the use of several rolls which can be controlled separately from one another, it is possible to adapt the displacement of the medium 101 to be printed through the ink jet printer 10 to different circumstances depending on the varying nature of the media, thereby making the ink jet printer 10 proposed by the invention very versatile in its use.

It should also be pointed out that the ink jet printer 10 proposed by the invention offers the user a decisive advantage insofar as different media can be printed using one and the same device, and the procedures needed to adapt the machine can be effected very rapidly. Consequently, the user is in a position to operate the ink jet printer 10 proposed by the invention in a mode which advantageously meets today's requirements, given that it is becoming increasingly common for one and the same company to be asked to print with a range of media within one and the same project, for example in the field of marketing.

Disposed in the region of the print heads 16 is a belt feed 44, consisting of several circulating belts 72, the exact operating mode of which will be described in more detail below with reference to FIG. 4.

Located downstream of the described region of the print heads 16 and the printing table 110 is a conveyor roll 46, which co-operates with a pressure roll 48 to bring the medium 101 into the correct position relative to the print heads 16, in particular drawing it across the brake roll 38 rotating in the opposite direction, in order to flatten it out and apply a defined tension to the medium 101. As illustrated, a pressure roll 48 is provided above the conveyor roll 46 and a pressure roll 50 is provided to the side of the conveyor roll 46. The top pressure roll 48 co-operates with the conveyor roll 46 and is used to convey boards in a horizontal direction, i.e. on the table 18 folded down into the horizontal position for this purpose. If a rolled medium is to be printed, as is the case in FIG. 1, and then reeled onto a roller 52 once it has been printed, the lateral pressure roll 50 engages with the conveyor roll 46, thereby assuming a conveyor function.

Disposed downstream of the conveyor roll 46 is a cutting mechanism 54, by means of which a rolled medium can be cut in order to produce rolls 56 of a smaller circumference than that of the medium roller 26 at the input end of the ink jet printer 10. As indicated in FIG. 1, smaller rolls 56 of this type can be mounted in an upper region of the device. If, on the other hand, the printed medium 101 is to be wound onto a relatively big roller 52 in the finished state, the latter will be mounted in a lower region when used in conjunction with the ink jet printer 10 proposed by the invention. From there, such a roll 52, which can no longer be manipulated and carried by a single operator, can be removed by a loading and unloading mechanism 58, for which the present applicant has recently filed an application and which is included in the scope of the subject matter of this application as far as the loading and unloading device 58 is concerned. It should also be pointed out that a loading and unloading device 58 of this type can be used to load a medium roller 26 at the input end (right-hand side in FIG. 1). Additional roller bearings may also be provided at the input end so that a rolled medium can be unreeled from relatively small rollers 56 in higher-up regions of the ink jet printer 10.

When printing flexible media such as paper and synthetic fibre materials, the ink jet printer 10 proposed by the invention operates as follows. The medium 101 is essentially drawn across the printing table 110 by the conveyor roll 46. This being the case, it is expedient to operate the belt feed 44 with suction openings that will be described in more detail with reference to FIG. 4, at least to keep the medium 101 flat. However, it may also be used to assist the process of feeding the medium 101 forward. The print is applied respectively in strips with a strip width of 70 mm, for example. Accordingly, it is also necessary for the medium 101 to be conveyed on an intermittent basis. This being the case, the medium 101 is drawn by the conveyor roll 46 co-operating with the pressure roll 48, as described, across the brake roll 39 rotating in the opposite direction so that the medium 101 is always kept tensed. As a result, its stiffness and the distance of the medium 101 from the outlet surface of the print head nozzles is kept constant, which is crucial to obtaining a good printing result.

After every printing operation, the feed roll 30 pushes the medium 101 far enough forward for the dancer roll 32 to be moved into the low position illustrated in FIG. 1, in which a sensor 36 underneath the dancer roll 32 is operated. This indicates that the requisite forward feed length has been reached and a control system 120 halts the feed roll 30. The material is then drawn farther along by the conveyor roll 46 so that it can be positioned in readiness for the next printing operation so that the dancer roll 32 is lifted. During the next forward feed by the feed roll 30, the material is again pushed forward to the extent that the dancer roll 32 is lowered and hits the sensor 36.

To impart a flexible design to the entire transport mechanism of the ink jet printer 10 proposed by the invention, it has proved to be of particular advantage to provide a dancer roll 32 for a roll which operates as a feed roll 30 when working with specific media. A dancer roll 32 of this type is attached to an arm 34, which is pivotably mounted on the base element 12. In a preferred embodiment of the invention, a dancer roll 32 of this type is combined with a sensor 36 so that the sensor 36 detects when the dancer roll 32 has been moved to a lowered position and generates a signal indicating a defined feed length. In other words, when the ink jet printer 10 proposed by the invention is operated in this manner, a conveyor roll 46 arranged downstream of the printing table 110 transports the medium 101 into the region of the print heads. This forward feed must be effected in a defined manner so that the strips intermittently printed on the medium 101 are correctly positioned relative to one another. To achieve the defined forward feed, the preferred embodiment of the invention ensures that after the medium 101 has been conveyed so that the medium 101 is tautened and the dancer roll 32 is therefore lifted, a forward motion is effected which causes the medium 101 to billow downwards, amongst other things due to the gravitational force of the dancer roll 32. This continues until the billow is sufficiently large and the position of the dancer roll 32 sufficiently low for the medium 101 to hit the described sensor 36, which then detects and indicates that the requisite forward feed length has been completed. A control device 120 then halts the feed roll 30.

In order to produce a defined feed length by an intermittent forward motion of the medium 101 along the guide surface 130, the dancer roll 32 forms a loop of the medium 101 so that the medium 101 is moved forward in the feed direction 137 until a distance perpendicular to the guide surface 130 of the medium 101 corresponds to a dimension of the next intermittent forward motion of the medium 101 across the guide surface 130, whereupon the medium 101 is held immobile on the side of the loop remote from the guide surface 130 and moved forwards relative to the guide surface 130 in the longitudinal direction of the medium 101 by a pre-settable dimension of the distance of the loop.

FIG. 6 illustrates a detail of the ink jet printer 10 with an alternative embodiment of the sensor 36 co-operating with the dancer roll 32. As explained in the description of FIG. 1, the medium 101 to be printed is fed underneath the dancer roll 32. The medium 101 is thus moved from the feed roll 30 and the corresponding pressure roll 40, underneath the dancer roll 32 and on across the brake roll 38 and the associated pressure roll 42 in the direction of the print head unit 14 (FIG. 1), the medium 101 being tensed by the dancer roll 32, which is displaceably mounted on the arm 34. The exact feed length of the medium 101 is then detected and indicated by the sensor 36, which in this case is an optical sensor. The sensor 36 is preferably a photoelectric arrangement, whereby the irradiation of one part of the sensor 36 is partially blocked off by the dancer roll 32 and medium 101 as they are lowered, which can be detected by a photoelectric receiver on a second part of the sensor. The corresponding signals are used by a control system 120 to determine the requisite feed length of the medium 101.

FIG. 2 illustrates the situation when printing a flexible and porous medium 101, for example cotton fabric, which will be used as flag material. Since this is a porous medium 101 which will be at least partially penetrated by the ink used for printing purposes, care must be taken to ensure that the printing table 110 underneath does not become soiled. For the purposes of the invention, this is done by using an ink absorbing unit consisting of an ink absorbing cushion 60 and two support edges 62 disposed to the side thereof. The ink absorbing unit is inserted in a receiving device in the receiving region of the printing table 110. These support edges 62 are inserted in the printing table 110 and are used to provide a defined guiding action of the medium 101 at a defined height above the printing table 110. Any ink which penetrates the porous medium 101 will be absorbed by the ink absorbing cushion 60 extending transversely across the printing table 110.

Another option is to provide the ink jet printer 10 with a printing table 110 which can be raised and lowered, for example. This will also enable allowance to be made for different circumstances which arise when printing different media. For example, the printing table 110 can be lowered to enable the use of an ink absorbing unit, provided for the ink jet printer 10 proposed by the invention. Using the ink absorbing unit imparts further flexibility to the ink jet printer 10 proposed by the invention, since it is possible to work with porous media such as fabrics with as little handling as possible, thereby ensuring safe and clean operation of the ink jet printer 10. Impermeable media such as paper, for example, can also be printed without edges by means of the ink jet printer 10 proposed by the invention, since any ink which spills over the edge of the medium 101 can be absorbed by the ink absorbing unit. The fact that the printing table 110 can be raised and lowered, as mentioned above, enables such an ink absorbing unit to be inserted rapidly and will also ensure that the position of the printing table 110 can be adapted to suit the requirements imposed by whatever medium 101 is being printed.

Since the medium 101 to be printed will be at a different height accordingly, the print head unit 14 containing the print heads 16 must be slightly raised, as illustrated in FIG. 2, and this can be seen by the fact that the pressure roll 40 co-operating with the feed roll 30 is in a raised position compared with the situation illustrated in FIG. 1, for example. The print heads are therefore disposed at a defined height above the medium 101 to be printed in the situation where the medium 101 to be printed is drawn across the support edges 62, as is the case with cotton fabric, thereby guaranteeing a high quality print. Alternatively or in addition to the above, the printing table 110 may be designed so that it can be lowered, as proposed by the invention, and this will make room for use of the support edges 62 and the ink absorbing cushion 60.

When printing fabric, the intermittent feed is again controlled by the conveyor roll 46, which engages with the pressure roll 48, which draws the medium 101 across the brake roll 38. The separately controllable feed roll 30 in this case is not used as a means of feeding the medium 101 forward and is in fact stationary. As a result, the medium 101 is pulled across the stationary feed roll 30, which causes a certain ironing out effect. To ensure that wear on the stationary roll 30 does not occur at a single point in this situation, this feed roll 30 is rotated by a few degrees at regular intervals so that the wear is distributed uniformly around the circumference. It is evident from this how versatile the ink jet printer 10 proposed by the invention is, lending itself to applications involving different media, due to the fact that the individual rolls can be controlled separately and in separate operating modes. It should also be pointed out that the ink absorbing cushion 60 together with the support edges 62 can also be used for non-porous media, if they are to be printed without edges, which will necessarily lead to at least a certain amount of spraying beyond the edges. Any ink which spills beyond the edges can be absorbed by the ink absorbing cushion 60 and the printing table 110 kept clean.

FIG. 3 illustrates how the ink jet printer 10 proposed by the invention may be adapted for printing paper boards of up to a certain basis weight. Up to a specific basis weight, the paper boards are fed along by the belt feed 44 only, the exact operation of which will be explained in detail below with reference to FIG. 4. The belt feed 44 has several circulating bands or belts 72 which convey the respective board as the bands or belts 72 move along.

In the preferred embodiment of the invention described below, a fold-down table 18 is provided at the medium input and/or discharge end and has a fold-down section 22 in its part closer to the print head unit 14.

In other words, a table 18 of this type can bring advantages to any type of printer, which need not necessarily incorporate the features defined in the main claim, so that this aspect of the subject matter should be construed as being within the scope of the subject matter of the application. The fact that a table 18 is designed to fold down at the medium input and/or discharge end makes the printer extremely flexible so that it can be set up to handle media in the form of rolls, boards or sheets. When the table 18 is in the folded-up state, rolled media can be printed which are unreeled from a roller, e.g. the medium roller 26, and once printed wound onto another roller, e.g. the roller 52. Whilst the table 18 is folded up, it does not hamper operation. In this state, further advantages are to be head from the described embodiment in which the table 18 has a fold-down section 22 in its region close to the print head unit 14. This means that when the table 18 is folded away, in particular in the folded-up state, a bottom section 22 can be folded out so that the region of the ink jet printer 10 in which the printing takes place is readily accessible. The fold-down section 22 of the fold-down table 18 is preferably designed so that it be folded upwards, thereby presenting no obstacle that will impede access to the interior of the ink jet printer 10 to speak of.

When using a table 18 of this type, it is also preferable to provide it with several rollers 20. The advantage of rollers 20, is that any boards to be printed, especially if they are particularly heavy, can be effortlessly fed through the ink jet printer 10, enabling the latter to be used for printing this type of medium.

As explained above, it is preferable for the fold-down section 22 of the table 18 to be mounted on the base element 12 so that it can be folded down about a point remote from the print head unit 14. This means that the fold-down section 22 can be folded away from the printer to a certain degree so that access hereto is impeded as little as possible. In particular, the fold-down section 22 can be folded upwards onto the folded-up table 18.

To operate the table 18 and the fold-down section 22 safely, advantages are also to be had if the table 18 and/or the fold-down section 22 can be locked in an operating and/or non-operating position. The operating position of the tables 18 corresponds to the position illustrated in FIG. 3, whilst the non-operating position of the tables 18 is that illustrated in FIGS. 1 and 2. Accordingly, the table 18 and the fold-down section 22 can be respectively placed in a defined secured position and it should further be pointed out that the table 18 and the fold-down section 22 may also be designed so that they assume their position due to stops and/or their own weight, for example by folding them upwards beyond a top dead centre.

Since, unlike rolled media, paper boards are not unreeled from rollers as explained above but are generally handled as separate boards, it is expedient to use the tables 18, which are preferably provided at both the input end and the discharge end. These are folded down into their horizontal position, enabling the boards to be fed through the ink jet printer 10 without difficulty by means of the various rollers 20. As may be seen from FIG. 3, the respective pressure rolls 40, 42 and 48 are released from the associated feed 30, brake 38 and conveyor 46 rolls since the material can be conveyed exclusively by means of the belt feed 44 in this instance. However, it should be pointed out that in the case of particularly heavy boards, the belt feed 44 may reach the limits of its operating capacity, in other words may not be strong enough to generate the feeding action. This being the case, the pressure rolls 40, 42 and 48 co-operating with the feed roll 30, the brake roll 38 or the conveyor roll 46, for example, may be engaged in order to move the material along.

The guide plane 138 for the medium 101 predefined by the tables 18 is disposed before the printing table 110, substantially flush with the guide plane 130. However, the guide plane 131 may also be slightly offset from the guide plane 130 in terms of height. However, it is of advantage for the guide plane 131 to follow a course which more or less conforms to the bending line of the medium 101 in the direction opposite the feed direction 137, since this will prevent the stiff medium 101 from bending in the region of the ink jet printer 10 due to too short a guide surface 130 relative to the length of the medium 101.

In the plan view shown in FIG. 4, both tables 18 are in their folded-out position. Each of the tables 18 has several rollers 20, which in the example illustrated are arranged in groups of three along their axial extension so that at least one end of the individual portions of the rollers 20 is mounted in one of the longitudinal struts 64. A fold-down section 22 may be seen in the region of the respective table 18 closer to the print head unit 14 (FIG. 3), which is mounted so that it folds out about a folding axis 24 in a region remote from the print head unit 14 (FIG. 3). In the example illustrated, the folding action of the fold-down portion 22 is damped by a gas compression spring 70. It should also be pointed out that the fold-down section 22 and/or the table 18 as a whole may be designed so that they can be locked in one or both folded positions.

The belt feed 44 may also be seen in FIG. 4 and consists of a plurality of belts 72, in this instance eight. The belts 72 extend in appropriate grooves, to which a vacuum pressure is applied from underneath, for example through the illustrated oblong holes 74. As a result of the numerous orifices 75 in the belts 72, the medium 101 is sucked down and conveyed by the motion of the belts 72. In order to place the medium 101 in a flat position, particularly during printing, suction orifices 76 are also provided in the printing table 110, which may be operated separately from the orifices 75 in the belts 72 for the purposes of the invention.

As a result of the belt feed 44, which consists of a plurality of circulating belts 72, each provided with orifices 75 in a preferred embodiment, the medium 101 is sucked down and held flat during printing. Suction orifices 76 are also provided in the printing table 110 between the belts 72 or bands, which also helps to hold the medium 101 flat. As mentioned above, the orifices 75 of the belts 72 and the suction orifices 76 of the printing table 110 may be operated at different vacuum pressures so that different suction forces can be applied to different regions of the medium 101, preventing flexible media from bending in any way which might impair the quality of the printing results. Whilst the belt feed 44 is in conveying mode, the stationary suction orifices 76 of the printing table 110 may also be switched off so that no unnecessary friction force is applied to the conveyed medium 101 in this region which would hamper conveyance by the belt feed 44. In order to generate the vacuum pressure described above, the orifices 75 in the belts 72 and the suction orifices 76 in the printing table 110 communicate with a vacuum system 77.

In a preferred embodiment of the invention, as mentioned above, a feed system is provided, having at least one belt 72 with orifices 75, which can be placed under a vacuum pressure. This imparts advantages to the belt feed 44 when it comes to handling specific media. The specific design of such a belt feed 44 may be such, for example, that a relatively flat and wide groove is provided in the printing table 110, in which an endless belt is guided. The belt 72 has orifices 75 and a connection to a vacuum system 77 is provided in the base of the groove. Since the belt 72 can be mounted so that its side sits in a sealing abutment at its edge, air is sucked by the vacuum system 77 through the orifices 75 of the belt 72, enabling any impermeable medium 101 that is being conveyed to be sucked by the belt 72 and carried along by the motion of the belt 72.

It has proved to be of particular advantage to combine this embodiment with a printing table 110 which also has suction orifices 76 but which can be supplied with vacuum pressure independently of the vacuum pressure applied to the belt feed 44, and which, in this respect, can be controlled. In other words, suction can be generated by the moving orifices 75 of the belt 72 and the stationary suction orifices 76 of the printing table 110 independently of one another. A particularly efficient means of keeping the medium 101 to be printed flat during printing can then be achieved by operating all the orifices 75 and suction orifices 76, for example. At the instant at which the medium 101 must be conveyed, the stationary suction orifices 76 of the printing table 110 will be switched off, however. Accordingly, suction occurs through the orifices 75 of the belt, i.e. belt 72, only and the conveying action will not be hindered as a result of increased friction due to suction through the stationary suction orifices 76. Finally, tests conducted for specific applications have shown that it is better to apply weaker suction at the stationary suction orifices 76 than at the moving orifices 75 of the belt 72 when handling certain media, since undesirable bending occurs otherwise. The fact of being able to operate and regulate the stationary and moving suction orifices independently of one another as described in respect of the preferred embodiment provides the option of adapting to the requirements of specific media. It should be pointed out that the embodiment described above and its associated features represents an embodiment of the invention which may also be used with a general ink jet printer which need not necessarily have the features defined in the main claim with the resultant advantages. In other words, a general ink jet printer with the features described above may be construed as an additional invention.

FIG. 5, finally, shows a roller mounting for a medium roller 26, from which the medium 101 is unreeled, and may be used with the ink jet printer 10 proposed by the invention or separately from it.

It is preferable to use a roller mounting with the ink jet printer 10 proposed by the invention, so that fewer adjustments will have to be made with regard to the edge of a rolled medium and which may therefore also be used independently of the other features proposed by the invention and may be construed as being within the scope of the subject matter of the present application. This roller mounting is distinctive because it can be adjusted in the axial direction 105 and because it co-operates with a strip edge sensor 104. In a conventional manner, flexible media, which need not necessarily be reeled perfectly straight or in which the quality of the reeling has been damaged during transport, may be cut at the edges so that the resultant cut edge is disposed in a defined position. This requires a not inconsiderable amount of time and leads to an unavoidable loss of material. For the purposes of the invention, however, the edge of the rolled medium, i.e. the medium 101, is continuously scanned and the axially adjustable roller bearing is shifted accordingly. In other words, if it is detected that the edge of the rolled medium has shifted slightly from its desired position, the roller mounting is axially displaced so that the edge of the web, i.e. the edge of the medium 101, is returned to the desired position. Since standard rolled media may have a diameter of up to approximately 30 cm, it is preferable for the strip edge sensor 104 to have a corresponding depth of field so that it will reliably detect the position of the edge of the medium 101 both in a situation where the medium 101 is being unreeled from a virtually full medium roller 26 and in a situation in which the medium 101 is being unreeled from a virtually empty medium roller 26.

As may be seen from FIG. 5, the medium roller 26 has a bearing pin 78 at both ends, which is provided with a relatively slim wheel with a V-shaped circumferential contour, for example, at one end, as it happens the right-hand side in FIG. 5. This slim wheel engages in at least one wheel 80 of the roller mounting provided with an appropriate groove. It is additionally provided with a strip edge sensor 104 as part of a belt edge measuring device, which constantly scans the position of the edge of the medium 101 and generates an appropriate signal if the edge of the medium 101 has move out of its desired position. In this situation, the adjustable roller mounting is shifted accordingly in the direction 105 so that the belt edge is returned to its desired position. Consequently, a medium 101 can be printed without having to cut the edges, as is the case with the prior art, in order to place it in the correct position. To this end, the wheel at the other end of the medium roller 26 is mounted in the roller mounting so that it can be displaced in the axial direction 105.

FIG. 13 is a perspective view showing a detail of the roller mounting for the medium roller 26 illustrated in FIG. 5. A control circuit is provided in order to ensure that the edge of the medium 101 can always be maintained in a pre-selectable desired position and consists of the strip edge sensor 104 of a belt edge control system 106 and a positioning drive 107. If the strip edge sensor 104 detects a variance in the desired edge of the medium 101, this variance will generate a signal in the belt edge control system 106, causing the positioning drive 107 to return the position of the medium roller 26 to the pre-selectable desired position. The positioning drive 107 is designed so that it can displace the roller mounting for the medium roller 26 in the axial direction 105. The position of the belt edge, i.e. the edge of the medium 101, may be determined on the basis of various measuring principles. It is of particular advantage to design the strip edge sensor 104 so that it operates a measuring system based on light sensors.

A new type of measuring and conveyor system may be used in conjunction with the ink jet printer 10 proposed by the invention, which is also independent of all the other features of the ink jet printer 10 proposed by the invention described above and will result in advantages if used with any other printers. The conveyor and measuring system is distinctive because a conveyor roll is provided both upstream and downstream of the printing table 110, each of which has a measuring system. In the layout illustrated in FIG. 1, the brake roll 38 is provided with a measuring system 102 and the conveyor roll 46 is provided with a measuring system 103. As a result, the position of the material to be printed, i.e. the medium 101, can be detected and controlled both upstream and downstream of the printing table 110 and the print heads 16, which in particular, as will be described below, leads to much less wastage. The leading edge of a medium 101 to be printed normally has to be fed forwards in a printer until the leading edge is detected by a conveyor roll 46 with a co-operating measuring system 103 downstream of the printing table 110 to enable the material to be placed in a defined position. With the new type of measuring system described below, the material or leading edge is positioned initially by means of the brake roll 38 disposed upstream, in other words “before” the printing table 110 and the print heads 16 and the measuring system assigned to the conveyor roll 46 thereof. In other words, the brake roll 38 disposed upstream places the leading edge of the medium 101 into an appropriate position for printing with the aid of the associated measuring system or measuring device 102 so that printing can be started at the leading edge of the medium 101 with virtually no edge or with extremely little waste. As the process of printing the medium 101 continues, the medium 101 is fed along by the conveyor roll disposed upstream of the printing table 110, i.e. fed forwards, until the leading edge reaches the region of the conveyor roll 46 disposed downstream of the printing table 110. At this instant at the earliest or optionally also at a later point in time, the downstream conveyor roll 46 and the measuring system or measuring device 103 associated with it assume control of the conveying action and regulate the exact position of the medium 101. In particular, these components may assume control of the feeding motion and regulating the position until the trailing edge of the medium 101 arrives in the region of the printing table 110, thereby enabling print to be applied with virtually no edge. By means of an appropriate control system 120, the signals of the two measuring systems 102, 103 are combined with one another and reconciled and the “handover” from the upstream system to the downstream system initiated.

The feed length may be measured in a number of ways. For example, it would be conceivable to provide markers at a fixed distance from one another on the medium 101 to be printed and use an appropriate sensor to detect them. In addition, a specific pattern with recurring elements may be applied to the medium 101 so that these recurring elements may be used as a means of detecting a feed length. This could also be provided in the form of a stochastic pattern, i.e. by the paper surface itself, in which case detection would be operated in conjunction with a correlation measurement. Another option would be to use a measuring wheel or a measuring system with a follower system. The measuring systems 102 and 103 may advantageously be used to measure the feed length of the medium 101 by applying coloured markings to the medium 101, which would only be visible under particular electromagnetic radiation. For example, markings could be applied to the medium 101that are only visible under UV light, in which case they would be detected by appropriate measuring systems 102 and 103 operating on a photoelectric basis.

FIGS. 7 to 9 provide simplified diagrams of systems provided with the ink jet printer 10 as a means of adapting the distances of the print heads 16 and print head unit 14 from the medium 101 to be printed. To this end, the ink jet printer is designed with a distance sensor 111 mounted on the print head 16 or print head unit 14. This distance sensor 111 is used for measuring a distance 112 between the top face 113 of the medium 101 to be printed and a nozzle or nozzles 114 of the print head unit 14 from which the ink is ejected. Since both the printing table 110 and the print head unit 14 can be raised and lowered, the ink jet printer 10 proposed by the invention is very flexible in its application and can be adapted to print a whole range of media 101 with virtually no additional equipment. In particular, it may be used to print media of a more or less board-type format of differing material thickness 115. Accordingly, the measurement variable generated by the distance sensor 111 may be used by an appropriate control system 120 to regulate the distance 112 between the top face 113 of the medium 101 and the nozzle or nozzles 114 of the print head unit 14 at any time to a desired value 121 to enable correct operation.

As illustrated in FIG. 7, the print heads 16 or the print head unit 14 is secured in a mount 122 and the height of this mount 122 can be adjusted vertically and horizontally in a height guide track 123 of a carriage 124 relative to the top face 113 of the medium 101. An elevator drive 125 activated by the control system 120 is used to adjust the height of the mount 122. The mount 122 for the print heads 16 can therefore be moved by the elevator drive 125 along the height guide track 123. The carriage 124, for its part, is mounted so as to be displaceable on a transverse guide track 126 by means of a displacement drive so that the print head unit 14 can be moved above the top face 113 sidewards and parallel with the top face 113 of the medium 101. The mount 122, the carriage 124 and the transverse guide track 126 with the elevator drive 125 together form a support 127 for the print head unit 14. The support 127 is in turn mounted on the machine frame 11 of the ink jet printer 10 so that it can be displaced on a support guide 128 in the vertical direction, the vertical displacement of the support 127 being operated by a vertical displacement mechanism 129 controlled by the control system 120. The support 127 of the print head unit 14 can therefore be displaced by a vertical displacement mechanism 129 at least almost perpendicular to a guide surface 130 for the medium 101. The printing table 110, which can be also be vertically displaced by means of a height guide 135, is arranged in the base element 12 and can be displaced by means of positioning drives 136 at least almost perpendicular to the guide surface 130 of the medium 101 and relative to the print head unit 14.

FIG. 8 is a diagram in section, showing a detail of the ink jet printer 10 illustrated in FIG. 7. The medium 101 to be printed lies on the guide surface 130 of the printing table 110. The diagram in FIG. 8 therefore corresponds to a view directed transversely to the feed direction 137 of the medium 101 and in the direction in which the support 127 and the print head unit 14 moves along the transverse guide track 126. The distance 112 between the nozzles 114 and the top face 113 of the medium 101 may be changed by various means. The height of the print head units 114 may be adjusted both by a vertical displacement of the mount 122 relative to the carriage 124 and by a vertical displacement of the support 127 on the support 128 secured to the machine frame 11. Finally, however, it is also possible for the height of the printing table 110 to be adjusted relative to the base element 12 by means of the positioning drive 136. In order to obtain the best possible result when printing the medium 101, the outlet orifices 138 of the nozzles 114 are disposed in a plane 139 of the top face 113 of the medium 101 and lying opposite the guide surface130 of the printing table 110, the plane 139 and the top face 113 of the medium 101 being aligned parallel with one another as far as possible.

FIG. 9 is a diagram in section illustrating a detail of the ink jet printer 10 with the carriage 124. The print heads 16, each of which is provided with a plurality of nozzles 114, can be displaced relative to the mount 122 by means of a print head elevator drive 140. Accordingly, the desired value 121 for the distance of the print head 16 from the top face 113 of the medium 101 can be adjusted on the basis of a measurement of the respective individual distance 112 of each and every print head 16. This is of particular advantage if, as described above, the feed mechanisms, i.e. the described rolls and/or belt feed 44 are not strong enough alone to line the medium 101 up flat on the guide surface 130 of the printing table 110. This could well be the case if specifically handling inherently stiff media 101, such as paper boards, plastics boards or similar, for example. A medium 101 to be printed in such a board-type format may have a slight bend which can not be eliminated sufficiently by the suction of the belt feed 101, for example. Alternatively, however, it would also be possible to provide at least two elevator drives 125, indicated by broken lines in FIG. 9, which tilt the mount 122 relative to the carriage 124 as the elevator drives 125, indicated by broken lines, are displaced by different distances. As a result, the plane 139 defined by the outlet orifices 138 of the nozzles 114 is deflected from its position parallel with the guide surface 130 but is then aligned as far as possible parallel with the region of the top face 113 lying directly opposite the nozzles 114. This approach also enables the individual distance 112 between the outlet orifices 138 and the top face 113 of the medium 101 to track the desired value 121.

FIG. 10 shows a detail of the mount 122 with a print head 16 with several nozzles 114. The individual nozzles 114 are respectively provided with a nozzle actuator 141 so that the distance 112 of the outlet orifice 138 of each nozzle 114 can be additionally adjusted by the control system 120. As a result, if the top face 113 of the medium 101 deviates from a planar alignment, the distances 112 of the outlet orifices 138 of the nozzles 114 can be even more accurately set. By preference, the nozzle actuator 141 is provided in the form of a micro-drive, for example a piezo-drive. This being the case, the nozzle actuator 141 provided as a micro-drive is designed so that the nozzle 114 acts against an elastically rebounding return element during displacement, e.g. a spring or an elastically resilient plastics such as a polyurethane ring. Naturally, however, it would also be possible for several nozzles 114 of a print head 16 to be provided with a nozzle actuator 141 or for a larger number of nozzles 114 to be grouped together in nozzle groups within a nozzle head 16, in which case a nozzle actuator drive 141 will be provided for each of these nozzle groups.

The systems described above for changing the distance 112 between the outlet orifices 138 of the nozzles 114 and the top face 113 of the medium 101 to be printed together form a displacement system which enables individual systems to be serviced both manually as well as jointly by means of the control system 120. Naturally, the displacement system of the ink jet printer 10 proposed by the invention could also consist of only some of the units, such as the positioning drive 136 for the printing table 110, the vertical displacement device 129 for the support 127, the elevator drive 125 for the mount 122, the print head elevator drive 140 for the print heads 16 and the nozzle actuator 141 for the nozzles 114.

Various methods may be used to enable the distance sensor 111 to determine distance 112 between the top face 113 of the medium 101 and the nozzle 114 or nozzles of the print head unit 14. For example, it would be possible to measure the distance 112 by mechanically scanning the top face 113 of the medium 101 to be printed. In specific embodiments of the ink jet printer 10, the distance 112 is advantageously measured by acoustic, electrical or optical distance measuring methods, since this will mean that there is no mechanical contact between the distance sensor 111 and the top face 113 of the medium 101 to be printed, which would rule out the risk of dye or ink that is still wet being smudged. If using measuring methods based on light or electromagnetic waves in general, for example, the distance sensor 111 may be provided in the form of a reflected light sensor or as a distance measuring system with an electro-optical receiver element.

For example, a coloured dot already applied could be used for measuring the distance 112 by directing a light beam onto this coloured dot and detecting the distance 112 on the basis of the light reflected by this coloured dot between a nozzle 114 of the ink jet printer 10 and the top face 113 of the medium 101 directed towards it.

In the embodiment of the ink jet printer 10 illustrated in FIG. 7, the distance sensor 111 is made up of at least two parts and consists of the a transmitter 142 and a receiver 143. The transmitter 142 and the receiver 143 are both attached to the print head unit 14. If the print heads 16 are arranged in the print head unit 14 so that they can be individually moved and in the situation where the nozzles 114 are disposed so that they can themselves be individually moved in the print heads 16, it is expedient to mount the transmitter 142 and the receiver 143 on the print heads 16 or on the nozzles 114. However, it would also be conceivable to use the distance sensor 111 with measuring methods in which one of the respective parts, i.e. the transmitter 142 or the receiver 143 is mounted on the print head unit 14 and/or on the print head 16 and/or on the nozzle 114, whilst the corresponding other part, i.e. the receiver 143 or the transmitter 142, is mounted on the printing table 110.

However, the distance sensor 111 may also be fixed to the side of the print head unit 14 and a respective distance sensor 111 can be mounted on both sides of the print head unit 14, i.e. one on each side, directed towards and away from the direction of movement of the print head unit 14 along the transverse guide track 126. Consequently, a distance sensor 111 is provided before each of the print heads 16, by reference to the feed direction thereof, corresponding to the direction of the transverse guide track 126, the advantage of which is that the localised distance 112 can be detected somewhat early. Alternatively, it would also be possible for the distance sensor 111 (indicated by broken lines in FIG. 8) to be mounted in advance on the print head unit 14 opposite the feed direction 137 of the medium 101. Apart from enabling the distance 112 to be indicated earlier in time than the actual printing process and hence the contour of the top face 113 of the medium 101 to be detected, this layout of the distance sensor 111 has an added advantage in that when the medium 101 is introduced, depending on the feed direction 137, the distance sensor 111 can simultaneously also be used to detect a front edge of the medium 101 extending transversely to the feed direction 137. This will prevent damage to the nozzles 114 of the print head unit if a medium 101 is introduced whose material thickness 115 is greater than the distance between the outlet orifice 138, the nozzles 114 and the guide surface 130 of the table 110. To this end, the control system 120 is designed to issue an error message, which will be generated immediately the sensor detects the top face 113 of the medium 101 if the distance 112 does not correspond to the desired value 121 and in particular is longer than the desired value 121.

As illustrated in FIG. 7, the distance sensor 111 is attached to the print head unit 14. However, it would of course also be possible for each of the print heads 16 to have a separate distance sensor 111, as illustrated in FIG. 9 or on every nozzle 114 as illustrated in FIG. 10. The advantage of this is that in co-operation with the control system 120, the distance 112 can be individually adapted for the nozzle heads 16 and also for the nozzles 114. Alternatively, another option would be to provide a distance sensor 111 on the printing table 110.

The distance sensor 111 forms a distance measuring system in conjunction with a transmission line and an evaluation unit or measurement converter. The evaluation unit or measurement converter is preferably disposed in the control system 120. The distance sensor 111 and the distance measuring system are therefore connected to the control system 120, which is in turn connected to the elements of the displacement system described above. The distance measuring system determines the actual value for the distance 112, which is compared with a pre-settable and adjustable desired value 121 in the control system 120. The difference established in the control system 120 between the actual value of the distance 112 and the desired value 121 will then form the basis for reducing this difference by activating the various elements of the displacement system of the ink jet printer 10. This being the case, the ink jet printer 10 is set up so that the actual value for the distance 112 is continuously determined by the distance measuring system as ink is being applied to the medium 101 by the print head unit 14. To this end, the control system 120 is also activated, preferably constantly and even before the print head unit 14 starts to apply ink to the medium 101 in order to reduce the difference between the desired value 121 and the actual value of the distance 112 during the time that ink is being applied to themedium 101.

In order to pre-select and pre-set the desired value 121, setting elements are provided on the control system 120. The control system 120 preferably has an electronic processor, preferably a computer, so that the desired value 121 can be pre-set from an associated input keyboard of the computer. However, it would also be possible for the desired value 121 to be input to the computer of the control system 120 on a programme-controlled basis, in which case other parameters essential for the printing process, e.g. the quality of the colours and inks used or the surface properties of the medium 101, will be automatically detected by the programme or can be manually entered from the input keyboard of the computer.

Using an ink jet printer 10 as proposed by the invention advantageously makes it possible to position the print head unit 14 in its relative position perpendicular to the plane of the support and/or guide surface 130 in a print position for applying print to the medium 101 at a distance 112 of at least 0.1 to 15 mm, preferably 0.5 to 10 mm.

FIGS. 11 and 12 illustrate details of the layout of the pressure roll 40 and the feed roll 30.

FIG. 11 illustrates a detail of the feed roll 30 and the pressure roll 40 from FIG. 3. The medium 101 in this instance lies on the feed roll 30, the situation illustrated being one in which the medium 101 is slightly deformed, such as can occur when working with an inherently stiff medium 101 such as paper or plastics boards, for example. Several pressure rolls 40 are provided, which are retained in a roll frame 144 so that they can be displaced in a direction perpendicular to this roll frame 144. The roll frame 144 can be raised and lowered with the pressure rolls 40 in a vertical direction, i.e. perpendicular to the guide surface 130. The pressure rolls 40 may be applied by lowering the roll frame 144 onto the top face 113 of the medium 101 so that it sits on the top face 113 and conforms to the slightly curved shape of this top face 113 of the medium 101. FIG. 12 is a detail illustrating the layout of the pressure rolls 40 and the feed roll 30 from FIG. 11 viewed in section. Every pressure roll 40 is rotatably mounted on an arm 145 and is supported on the roll frame 144 by means of an elastically resilient return element 146, e.g. a spring.

When the roll frame 144 together with the pressure rolls 40 is applied to the top face 113 of the medium 101 with a predefined force, the return elements 146 are compressed accordingly. From a mean height of the roll frame 144 from the guide surface 130 obtained as a result, it will be possible to derive the mean material thickness 115 of the medium 101. A mean material thickness 115 can be determined to a sufficiently accurate degree with only slightly deformed media 101 and this value used as the basis for setting the distance 112 (FIG. 7) to the desired value 121 (FIG. 7) with the aid of the control system 120.

The arrangement illustrated in FIGS. 11 and 12 therefore fulfils the function of a distance measuring system such as that achieved by the distance sensor 111 and can be used in a distance measuring system in combination with or as an alternative to the distance sensor 111. Naturally, it would also be possible to provide a separate arrangement of rolls on the ink jet printer 10 separately from the feed roll 30 and the pressure roll 40 for use as a distance measuring system in the manner described above,. The particular advantage of using the distance measuring system illustrated in FIGS. 11 and 12 is that when media 101 of a board-type format with a bigger material thickness 115 are introduced, the medium 101 can not be introduced into to the region of the print head unit 14 unless the material thickness 115 has been registered by means of a monitoring device and the print head unit 14 has been moved vertically by means of the control system 120, thereby enabling the desired value 121 to be set. Particularly if using an appropriate monitoring system in co-operation with the control system 120, the medium 101 will be prevented from being fed to the region of the print head unit 14 and the printing process set in motion in a manner likely to cause errors.

In the case of stiff, especially inherently stiff media which have a stiffness transversely to their feed direction 137 rendering the use of lateral guiding or orientation means in the lateral direction possible, it is of advantage if a lateral guide track 150 for the longitudinal side edge 151 of the medium 101 is provided for the medium 101, at least along a part of the length of the guide surface 130 in the feed direction 137. This lateral guide track 150 comprises several rollers 152 mutually spaced at the requisite distance in the longitudinal direction of the medium 101, which can be mounted in a stationary arrangement on a housing part 153 which is adjustable transversely to the feed direction 137.

By preference, these rollers 152 are made from a pressure-resistant material so that the lateral guide track 150 constitutes an exact direction and lateral boundary for the medium 101. If working with specific inherently stiff media 101, it may be of advantage to keep these constantly in exact alignment against the lateral guide track 150. To this end, it may be of advantage to provide another lateral guide track 155 for the other longitudinal side edge 154 of the medium 101 lying opposite the longitudinal side edge 151. It may also consist of a plurality of rollers 152 arranged flush one after the other, in which case every individual roller 152 or groups of rollers 152 or the entire lateral guide track 155 can be mounted so as to be displaceable transversely to the feed direction 137 against the action of elastically biassed means 165, e.g. springs, in the direction of the oppositely lying lateral guide track 150. The rollers 157 of the lateral guide track 155 may also be dimensionally stable or hard, in which case they may be provided in the form of outer rings of ball bearings, for example. However the elastically biassed means could also be designed so that the rollers 157 can be coarsely adjusted on a housing part and the rollers 157 may be of an elastic design, for example made form an elastically flexible synthetic material or rubber-like material, e.g. polyurethane. Accordingly, in the event of slight fluctuations in the width of the medium 101 to be printed, the reference edge of the medium 101 will always lie with the longitudinal side edge 151 against the lateral guide edge 150 without any clearance and any width tolerances will be compensated by the deformation of the rollers 157 and the deformation of the springs. Furthermore a biassing force in the direction of the lateral guide track 150 can be pre-set accordingly so that the reference edge of the medium 101 will be guaranteed to sit against the lateral guide track 150 even if the width is short in dimension.

With the ink jet printer 10 proposed by the invention described above, it will be possible to run a process of printing different media by ink jet printing, whereby the medium 101 is moved into the region of an ink jet printer and a reproduction of an image produced on the basis of digital data for a digitally stored image, including position, intensity and/or a colour of a plurality of print dots, and to displace an essentially inherently stiff medium 101 in board-type format, optionally having determined its material thickness 115 relative to a planar support or guide surface 130, into the region of an ink jet printer, after which a plurality of nozzles 114 disposed in a plane extending parallel with the top face 113 of the medium 101 is displaced transversely to the feed direction 137 of the medium 101, relative to the latter, across the entire printing width whilst simultaneously applying a plurality of lines of ink dots to the medium 101 one after the other in the feed direction 137, whereupon the nozzles 114 are moved transversely to the feed direction 137 of the medium 101, relative thereto, across the entire printing width at least one more time in order to apply yet another plurality of lines of ink dots one after the other in the feed direction 137 of the medium 101 perpendicular to the surface of the medium 101 onto the ink dots previously applied or the surface of the medium 101 or the medium 101 can be moved forwards in the feed direction 137 by the number of lines produced with the nozzles 114 and the medium 101 intermittently fed forwards or printed in alternation until the end of the image and/or the medium 101 is reached. By preference, the material thickness 115 of the substantially inherently stiff medium 101 in board-type format is checked before it is moved on to a flat support or guide surface 130 and the forward feed of the medium 101 is not permitted unless an actual value matches the desired value 121.

The essentially inherently stiff board-format medium 101 is also supported and/or guided at least along a part of its length in the feed direction 137 before and optionally after the guide surface 130 approximately in the same plane by means of guide elements which are stationary relative to the medium 101.

In particular, the ink jet printer 10 proposed by the invention may be used to run a process for printing different media with digitally stored images. On the basis of digital data for a digitally stored image, such as the position, intensity and/or a colour of an area of ink dots, a reproduction of an image can be produced, and an actual value for the distance 112 between the print head unit or print heads or nozzles 114 of the ink jet printer and a top face of the medium 101 directed towards the nozzles 114 and/or the guide surface 130 and/or the strip edge of the medium 101 can be determined and a pre-settable desired value 121 for the distance 112 and/or the position of the medium roller 26 transversely to the feed direction 137 of the medium 101 relative to the base element pre-set. It is also of advantage if the ink jet printer is set up, at least before it starts applying ink, so that the actual value of the distance 112 between the print head unit or print heads or nozzles 114 of the ink jet printer and a top face of the medium 101 directed towards the nozzles 114 and/or the guide surface 130 matches the pre-settable desired value 121 for the distance 112. Similarly, at least before the medium 101 is introduced into the region of the print head unit, a pressure roll co-operating with and/or disposed before the ink jet printer and/or the distance measuring system is set to an actual value for the distance 112 matching the pre-settable desired value 121 of the distance 112 between the print head unit or print heads or nozzles 114 of the ink jet printer and a top face of the medium 101 directed towards the nozzles 114 and/or the guide surface 130 and a check is run to ascertain whether the top face of the medium 101 is disposed at a distance 112 such that a top face of the medium 101 directed towards the nozzles 114 and/or the guide surface 130 deviates from the desired distance 121.

To prevent material losses of the medium 101, it is of particular advantage if the roller mounting for the medium roller 26 is displaced by the positioning drive 107 in an axial direction 105 disposed transversely to the feed direction so that the strip edge of the medium 101 coincides with the desired value in the region of the print head unit and the actual value of the strip edge is detected in the region of the print head or immediately before it.

The quality of the images produced with an ink jet printer proposed by the invention can be improved, especially if the distance 112 between at least one nozzle 114 of the ink jet printer and the medium 101 and/or the position of the medium roller 26 is continuously detected whilst ink is being applied with the print head unit and the difference between the desired and actual value of the distance 112 and/or the position of the medium roller 26 determined as the ink is being applied.

Since the distance 112 in the direction of displacement of the nozzles 114 of the print head and/or the medium 101 is detected at a pre-settable distance before the nozzles 114, contours of the top face 113 of the medium 101 can be determined early with a clear gain in time so that the requirements for operating the control system 120 at speed are significantly reduced.

List of reference numbers

| | |
|---|---|
| 10 | Ink jet printer |
| 11 | Machine frame |
| 12 | Base element |
| 14 | Print head unit |
| 16 | Print head |
| 18 | Table |
| 20 | Roller |
| 22 | Section |
| 24 | Folding axis |
| 26 | Medium roller |
| 28 | Deflector roll |
| 30 | Feed roll |
| 32 | Dancer roll |
| 34 | Arm |
| 36 | Sensor |
| 38 | Brake roll |
| 40 | Pressure roll |
| 42 | Pressure roll |
| 44 | Belt feed |
| 46 | Conveyor roll |
| 48 | Pressure roll |
| 50 | Pressure roll |
| 52 | Roller |
| 54 | Cutting mechanism |
| 56 | Roller |
| 58 | Unloading device |
| 60 | Ink absorbing unit |
| 62 | Support edge |
| 64 | Longitudinal struts |
| 70 | Gas compression spring |
| 72 | Belt |
| 74 | Oblong hole |
| 75 | Orifice |
| 76 | Suction orifice |
| 77 | Vacuum system |
| 78 | Bearing pin |
| 80 | Wheel |
| 101 | Medium |
| 102 | Measuring system |
| 103 | Measuring system |
| 104 | Strip edge sensor |
| 105 | Direction |
| 106 | Strip edge control system |
| 107 | Positioning drive |
| 110 | Printing table |
| 111 | Distance sensor |
| 112 | Distance |
| 113 | Top face |
| 114 | Nozzle |
| 115 | Material thickness |
| 120 | Control system |
| 121 | Desired value |
| 122 | Mount |
| 123 | Height guide track |
| 124 | Carriage |
| 125 | Elevator drive |
| 126 | Transverse guide track |
| 127 | Support |
| 128 | Support guide |
| 129 | Displacement mechanism |
| 130 | Guide surface |
| 131 | Guide plane |
| 135 | Height guide |
| 136 | Positioning drive |
| 137 | Feed mechanism |
| 138 | Outlet orifice |
| 139 | Plane |
| 140 | Print head elevator drive |
| 141 | Nozzle actuator |
| 142 | Transmitter |
| 143 | Receiver |
| 144 | Roll frame |
| 145 | Arm |
| 146 | Return element |
| 150 | Lateral guide track |
| 151 | Longitudinal side edge |
| 152 | Roller |
| 153 | Housing part |
| 154 | Longitudinal side edge |
| 155 | Lateral guide track |
| 156 | Means |
| 157 | Roller |

1. Ink jet printer for different media with a print head unit having at least one print head for applying print to the medium and a printing table for positioning and/or guiding the medium to be printed, an adjusting mechanism for varying a distance between the print head unit and the medium in a direction perpendicular to the guide surface as well as a control system, characterised in that a base element (12) and/or a printing table (110) is disposed on a machine frame (11) and one of the two constitutes a support or guide surface (130) for a medium (101) aligned in a plane and a feed system is provided on the printing table (110) and/or base element(12) to feed through a virtually inherently stiff medium (101), and a print head unit (14) can be displaced by means of a displacement drive along a transverse guide track (126) disposed on the machine frame (11) extending parallel with the plane and transversely to the feed direction (137) and incorporates several nozzles (114) for applying inks, the outlet orifices (138) of which are distributed in a same plane (139) parallel with the plane.

2. Ink jet printer as claimed in claim 1, characterised in that the print head unit (14) can be positioned perpendicular to the plane of the support and/or guide surface (130), at least within a distance (112) of from 0.1 to at least 15 mm, preferably 0.5 mm to 10 mm, in a printing position for applying print to the medium (101).

3. Ink jet printer as claimed in claim 1 or 2, characterised in that the a guide plane (131) for the medium (101) before and optionally after the support and/or guide surface (130) in the feed direction (137) of the medium (101) is aligned substantially flush with or slightly offset in height from the plane of the bearing and/or guide surface (130).

4. Ink jet printer as claimed in one or more of the preceding claims, characterised in that the guide plane (131) of the support and/or guide surface (130) has a contour more or less corresponding to the bending line of the medium (101) in the direction opposite the feed direction (137) thereof.

5. Ink jet printer as claimed in one or more of the preceding claims, characterised in that the support and/or guide surface (130) is arranged before the distance measuring system and/or a monitoring system for the material thickness (115) of the medium (101) in the feed direction (137) of the medium (101).

6. Ink jet printer as claimed in one or more of the preceding claims, characterised in that the medium (101) is guided in the feed direction (137) at the side along a lateral guide track (150), at least along a part of the length of the support and/or guide surface (130).

7. Ink jet printer as claimed in one or more of the preceding claims, characterised in that the lateral guide track (150) is provided in the form of dimensionally stable rollers (152) arranged one after the other in the feed direction (137).

8. Ink jet printer as claimed in one or more of the preceding claims, characterised in that both longitudinal sides of the medium (101) extending in the feed direction (137) co-operate with a lateral guide track (150, 155).

9. Ink jet printer as claimed in one or more of the preceding claims, characterised in that one of the two lateral guide tracks (150, 155) is displaceable transversely to the feed direction (137) against the action of means (157) elastically biassed in the direction of the oppositely lying guide track (150).

10. Ink jet printer as claimed in one or more of the preceding claims, characterised in that one of the two lateral guide tracks (150, 155) is provided in the form of rollers (152, 157) with a periphery which deforms in an elastically resilient arrangement.

11. Ink jet printer as claimed in one or more of the preceding claims, characterised in that several feed mechanisms for the medium (101) are provided, which can be activated and/or grouped, preferably separately from one another, opposite the printing table (110) on a preferably height-adjustable support (127) of the print head unit (14) and/or on the printing table (110).

12. Ink jet printer as claimed in one or more of the preceding claims, characterised in that the feed mechanisms are provided in the form of several separately drivable and controllable rolls for guiding the medium (101) to be printed lengthways, sideways and or in height (135).

13. Ink jet printer as claimed in one or more of the preceding claims, characterised in that the rolls are designed and disposed with a view to applying a feed force to the medium (101) to transmit a feeding motion in the feed direction (137) of the medium (101) to be printed and/or for applying a braking force acting in the direction opposite the feed direction (137) of the medium (101).

14. Ink jet printer as claimed in one or more of the preceding claims, characterised in that the feed roll (30) and/or the brake roll (38) and/or the conveyor roll (46) co-operate with pressure rolls (40, 42, 48) which can be brought into and out of engagement.

15. Ink jet printer as claimed at least in one of the preceding claims, characterised in that a stationary guide mechanism, preferably a blocked roll, is provided, by and with which a material to be printed can be slidingly placed in abutment during printing.

16. Ink jet printer as claimed in one or more of the preceding claims, characterised in that the feed mechanism is provided in the form of a belt feed (44).

17. Ink jet printer as claimed in one or more of the preceding claims, characterised in that at least the side of the belt (72) of the belt feed (44) directed towards the top face (113) medium (101) is provided with pores and/or orifices (75) to allow air through and these orifices (75) are connected to a vacuum system (77).

18. Ink jet printer as claimed at least in one of the preceding claims, characterised in that a belt (72) of the belt feed (44) has orifices (75) and a vacuum pressure can be applied to the belt.

19. Ink jet printer as claimed in one or more of the preceding claims, characterised in that suction orifices (76) communicating with a vacuum system (77) are provided in the guide surface (130) of the printing table (110).

20. Ink jet printer as claimed in one or more of the preceding claims, characterised in that the orifices (75) co-operate with the belt of the belt feed (44).

21. Ink jet printer as claimed in one or more of the preceding claims, characterised in that suction orifices (76) are provided in the guide surface (130) of the printing table (110) in the regions adjacent to the belt (72).

22. Ink jet printer as claimed at least in one of the preceding claims, characterised in that a respective independent, preferably different vacuum pressure, which can be individually switched off, can be applied at the suction orifices (76) of the printing table (110) and at the orifices (75) in the belt (72) and this vacuum pressure can be regulated.

23. Ink jet printer as claimed in one or more of the preceding claims, characterised in that a feed roll (30) is provided before a dancer roll (32) and co-operates with a measurement transmitter having a sensor (36) for detecting the distance of the dancer roll (32) perpendicular to the guide surface (130) of the medium (101).

24. Ink jet printer with an ink absorbing unit, characterised in that a receiving device is provided in the region of the receiving surface of the printing table (110) for an ink absorbing unit which may be used and/or activated if necessary.

25. Ink jet printer as claimed in one or more of the preceding claims, characterised in that the ink absorbing unit has support edges (62).

26. Ink jet printer as claimed at least in one of the preceding claims, characterised in that it has a fold-down table (18) at the medium input and/or discharge end, which has a fold-down section (22) in its part closer to the printer.

27. Ink jet printer as claimed in one or more of the preceding claims, characterised in that the table (18) is provided with a plurality of rollers (20).

28. Ink jet printer as claimed in one or more of the preceding claims, characterised in that the fold-down section (22) is mounted on the table (18) so that it can be folded down at a point farther away from the printers.

29. Ink jet printer as claimed in one or more of the preceding claims, characterised in that the table (18) and/or the fold-down portion (22) can be locked in an operating and/or a non-operating position.

30. Ink jet printer as claimed at least in one of the preceding claims, characterised in that a respective measuring device (102, 103) is provided both upstream and downstream of the printing table (110) and guide surface (130), preferably in the region of a conveyor roll (46) and a brake roll (38), for detecting longitudinal markers or front edges of the medium (101) extending transversely to the feed direction (137).

31. Ink jet printer as claimed in claim 30, characterised in that the measuring devices (102, 103) are disposed in the region of material supports.

32. Ink jet printer for media having a print head unit with at least one print head for applying print to the medium and a printing table for positioning and/or guiding the medium to be printed, a displacement mechanism for varying a distance between the print head unit and the medium in a direction perpendicular to the guide surface (130), and having a control system, in particular as claimed in one of claims 1 to 31, characterised in that the control system (120) is connected to a distance and/or strip edge measuring device, the displacement mechanism and a positioning drive (107) for a medium roller (26), and has an input device for pre-setting a desired value (121) for the distance (112) between the print head (16) or a nozzle (114) arranged therein and a top face (113) of the medium (101) directed towards the print head (16) or this nozzle (114) and/or a guide surface (130) of the printing table (110) and/or for the position of the medium roller (26) transversely to the feed direction (137) relative to the base element (112).

33. Ink jet printer as claimed in one or more of the preceding claims, characterised in that the displacement mechanism is activated by the control system at least before the medium (101) is introduced into the region of the print head unit (14) in order to reduce a difference between the desired value (121) pre-set in the control system (120) and an actual value for this distance (112) detected by the distance measuring device.

34. Ink jet printer as claimed in one or more of the preceding claims, characterised in that a displacement mechanism is activated by the control system (120) at least before the medium (101) is introduced into the region of the print head unit (14) in order to reduce a difference between the desired value for the position of the medium roller (26), which can be pre-set in the control system (120), and an actual value for this distance (112) detected by the distance measuring device.

35. Ink jet printer as claimed in one or more of the preceding claims, characterised in that the distance measuring system has a sensor for scanning the top face (113) of the medium (101).

36. Ink jet printer as claimed in one or more of the preceding claims, characterised in that the control system (120) is set up to emit an error message if the sensor detects the top face (113) of the medium (101) and the distance (112) does not match the desired value (121), in particular if it is greater than the desired value (121).

37. Ink jet printer as claimed in one or more of the preceding claims, characterised in that the control system (120) is set up to emit an error message if the desired value (121) corresponds to the distance (112) and the sensor does not detect the top face (113) of the medium (101).

38. Ink jet printer as claimed in one or more of the preceding claims, characterised in that the actual value of the distance (112) may be continuously detected by the distance measuring system whilst ink is being applied to the medium (101) by the print head unit (14).

39. Ink jet printer as claimed in one or more of the preceding claims, characterised in that the control system (120) is activated, preferably constantly, in order to reduce the difference between the desired and the actual value of the distance (112) whilst ink is being applied to the medium (101) by the print head unit (14).

40. Ink jet printer as claimed in one or more of the preceding claims, characterised in that the control system is activated in order to reduce the difference between the desired and the actual value of the distance (112) before the print head unit (14) starts to apply ink to the medium (101).

41. Ink jet printer as claimed in one or more of the preceding claims, characterised in that outlet orifices (138) of the nozzles (114) of the print head (16) of the print head unit (14) are disposed at the pre-settable distance (112) lying opposite a flat guide surface (130) for the preferably inherently stiff medium (101).

42. Ink jet printer as claimed in one or more of the preceding claims, characterised in that outlet orifices (138) of the nozzles (114) of the print head (16) of the print head unit (14) are disposed in one plane (139) and a guide surface (130) for the preferably inherently stiff medium (101) is disposed lying opposite them at the pre-settable distance (112).

43. Ink jet printer as claimed in one or more of the preceding claims, characterised in that the guide surface (130) is designed for flexible and inherently stiff media.

44. Ink jet printer as claimed in one or more of the preceding claims, characterised in that the distance measuring system has a distance sensor (111) disposed in the region of the print head unit (14) and/or on the printing table (110) and is connected to the control system (120) for detecting the actual value of the distance (112).

45. Ink jet printer as claimed in one or more of the preceding claims, characterised in that the distance measuring system has a distance sensor (111) disposed at least on a print head and/or on the printing table (110) and is connected to the control system (120) for detecting the actual value of the distance (112).

46. Ink jet printer as claimed in one or more of the preceding claims, characterised in that the distance measuring system has a distance sensor (111) disposed on the nozzle (114) of the print head (16) or adjacent thereto.

47. Ink jet printer as claimed in one or more of the preceding claims, characterised in that the distance sensor (111) for measuring the distance (112) is designed to operate by means of acoustic and/or electric waves, e.g. is an ultrasound sensor.

48. Ink jet printer as claimed in one or more of the preceding claims, characterised in that the distance sensor (111) for measuring the distance (112) is designed to operate by means of electromagnetic waves, e.g. is a reflected light sensor.

49. Ink jet printer as claimed in one or more of the preceding claims, characterised in that the distance sensor (111) for measuring the distance (112) is provided in the form of an optical or electromechanical distance sensor, optionally as a distance sensor with an electro-optical, digital or analogue receiver (143), e.g. a CCD array.

50. Ink jet printer as claimed in one or more of the preceding claims, characterised in that the distance sensor (111) consists of several parts, e.g. a transmitter (142) and a receiver (143), and both parts are disposed on the print head unit (14) or on the print head or nozzle (114).

51. Ink jet printer as claimed in one or more of the preceding claims, characterised in that one of the two parts of the distance sensor (111), e.g. the transmitter (142) or receiver (143), is disposed on the print head unit (14) and/or on the print head and/or the nozzle (114) and the other part of the distance sensor (111), e.g. the receiver (143) or transmitter (142) of the distance sensor (111), is mounted on the print head and/or the nozzle (114) on the printing table (110).

52. Ink jet printer as claimed in one or more of the preceding claims, characterised in that the distance sensor (111) is disposed at a pre-settable distance before the nozzles (114) of the print head (16) in the feed direction (137) of the medium (101) and/or the print head (16).

53. Ink jet printer as claimed in one or more of the preceding claims, characterised in that the control system (120) has setting elements for pre-selecting a desired value (121) for the distance (112).

54. Ink jet printer as claimed in one or more of the preceding claims, characterised in that the control system (120) is an electronic processor, in particular a computer.

55. Ink jet printer as claimed in one or more of the preceding claims, characterised in that the desired values (121) for the distance (112) can be pre-set from an input keyboard of the computer.

56. Ink jet printer as claimed in one or more of the preceding claims, characterised in that a support (127) of the print head unit (14) can be displaced substantially perpendicular to the guide surface (130) for the medium (101) and the printing table (110) and the base element (12) by means of a vertical displacement mechanism (129).

57. Ink jet printer as claimed in one or more of the preceding claims, characterised in that the print heads (16) can be displaced relative to one another with respect to the print head unit (14) by means of a print head elevator drive (140) substantially perpendicular to a mount (122) of the print heads.

58. Ink jet printer as claimed in one or more of the preceding claims, characterised in that the mount (122) is displaceably mounted in a carriage (124) which can be moved in a transverse guide track (126) oriented so that it extends transversely to the longitudinal extension of the guide surface (130) and in a height guide track (123) disposed perpendicular to the transverse guide track (126).

59. Ink jet printer as claimed in one or more of the preceding claims, characterised in that the mount (122) for the print heads (16) can be displaced along the height guide track (123) by means of an elevator drive (125).

60. Ink jet printer as claimed in one or more of the preceding claims, characterised in that at least one nozzle (114) in the print head (16) can be displaced by a nozzle actuator (141) in a direction more or less perpendicular to the guide surface (130) for the medium (101).

61. Ink jet printer as claimed in one or more of the preceding claims, characterised in that the nozzle actuator (141) is a micro-drive, for example a piezo-drive.

62. Ink jet printer as claimed in one or more of the preceding claims, characterised in that the nozzle (114) can be displaced by the micro-drive against the action of an elastically re-bounding return element, e.g. a spring or an elastically rebounding synthetic material, for example a polyurethane ring.

63. Ink jet printer as claimed in one or more of the preceding claims, characterised in that a nozzle actuator is provided in the print head (16) for several nozzles (114).

64. Ink jet printer as claimed in one or more of the preceding claims, characterised in that the nozzles (114) are grouped in nozzle groups in a nozzle head and a nozzle actuator is provided for every nozzle group.

65. Ink jet printer as claimed in one or more of the preceding claims, characterised in that the printing table (110) can be displaced by means of positioning drives (136) substantially perpendicular to the guide surface (130) of the medium (101) and relative to the print head unit (14).

66. Ink jet printer as claimed in one or more of the preceding claims, characterised in that the printing table (110) displaceable by means of the positioning drives (136) is mounted so as to slide in a height guide (135) mounted on the base element (12).

67. Ink jet printer, in particular as claimed in one of the preceding claims, characterised in that it has a strip edge sensor (104) and the medium roller (26) is retained and guided on a roller mounting perpendicular and transversely to the feed direction, which can be displaced in an axial direction (105) by the positioning drive (107).

68. Ink jet printer, in particular as claimed in one of the preceding claims, characterised in that the strip edge sensor (104) is disposed in the region of the print head unit (14) or immediately before it.

69. Ink jet printer for rolled and sheet media, flexible and stiff as well as impermeable and porous media, having:
a print head unit (14) which can be raised and lowered with at least one print head (16) for applying print to the medium (101),
a printing table (110) which can be raised and lowered, by means of which the medium (101) to be printed is guided at the instant of printing,
an ink absorbing unit which can be used in the region of the printing table (110) and
several rolls which can be controlled separately from one another and can be used as conveyor (46) and/or feed (30) and/or brake rolls (38) and by which the medium to be printed (101) is conveyed and/or moved forward by a defined feed length and/or braked, in order to pull it taut.

70. Method of applying print to different media by ink jet printing, whereby the medium is introduced into the region of an ink jet printer and digital data for a digitally stored image, such as the position, intensity and/or a colour of a plurality of coloured dots, is used to produce a reproduction of the image, in particular as claimed in one of claims 1 to 69, characterised in that an essentially inherently stiff board-type medium is conveyed, optionally after detecting its material thickness, relative to a flat support or guide surface, into the region of an ink jet printer, after which a plurality of nozzles disposed in a plane extending parallel with the top face of the medium is moved relative thereto, transversely to the feed direction of the medium, across the entire printing width whilst a plurality of lines of coloured dots is simultaneously applied one after the other in the feed direction of the medium and the nozzles are then moved once again transversely to the feed direction of the medium and relative thereto across the entire printing width in order to apply another plurality of lines of coloured dots in the feed direction of the medium one after the other in a direction perpendicular to the surface of the medium onto the previously made coloured dots, or the top face of the medium or the medium is moved forwards in the feed direction by the number of lines produced with the nozzles and the medium is intermittently fed forward or printed in alternation until reaching the end of the image and/or the medium.

71. Method as claimed in claim 70, characterised in that before the essentially inherently stiff board-type medium is moved forward onto a flat support or guide surface, its material thickness is checked and the forward feed of the medium is not permitted unless an actual value matches the desired value.

72. Method as claimed in claim 70 or 71, characterised in that the essentially inherently stiff board-type medium is supported and/or guided, at least across a part of its length, in the feed direction before and optionally after the support or guide surface in virtually the same plane by means of guide elements which are stationary relative to the medium.

73. Method of applying print to different media by ink jet printing, whereby the medium is introduced into the region of an ink jet printer and digital data for a digitally stored image, such as the position, intensity and/or a colour of a plurality of coloured dots, is used to produce a reproduction of the image, in particular as claimed in one of claims 1 to 72, characterised in that an actual value of the distance between the print head unit and print heads and nozzles of the ink jet printer and a top face of the medium directed towards the nozzles and/or the guide surface and/or the strip edge of the medium is detected and a pre-settable desired value is set for the distance and/or the position of the medium roller transversely to the feed direction of the medium, relative to the base element.

74. Method as claimed in one of claims 70 to 73, characterised in that the ink jet printer is adjusted, at least before the start of ink ejection, to an actual value for the distance between the print head unit or print heads or nozzles of the ink jet printer and a top face of the medium directed towards the nozzles and/or the guide surface, which matches the pre-settable desired value of the distance.

75. Method as claimed in one of claims 70 to 74, characterised in that, at least before introducing the medium into the region of the print head unit, a pressure roll and/or the distance measuring system co-operating with and disposed before the ink jet printer is set to an actual value for the distance between the print head unit or print heads or nozzles of the ink jet printer and a top face of the medium directed towards the nozzles and/or the guide surface, which matches the pre-settable desired value of the distance and it is then ascertained whether the top face of the medium is disposed such that a distance from the top face of the medium directed towards the nozzles and/or the guide surface deviates from the desired value.

76. Method as claimed in one of claims 70 to 75, characterised in that the roller mounting for the medium roller with the positioning drive is displaced in an axial direction transversely to the feed direction so that the strip edge of the medium is disposed so that it conforms to the desired value in the region of the print head unit.

77. Method as claimed in one of claims 70 to 76, characterised in that the actual value of the strip edge is detected in the region of the print head unit or immediately before it.

78. Method as claimed in one of claims 70 to 77, characterised in that the distance between at least a nozzle of the ink jet printer and the medium and/or the position of the medium roller is detected continuously whilst ink is being applied by the print head unit.

79. Method as claimed in one of claims 70 to 78, characterised in that the difference between the desired and the actual value of the distance and/or the position of the medium roller is detected whilst ink is being applied.

80. Method as claimed in one of claims 70 to 79, characterised in that the distance is detected in the direction of displacement of the nozzles of the print head and/or of the medium before the nozzles at a pre-settable distance.

81. Method as claimed in one of claims 70 to 80, characterised in that a marker, e.g. a coloured dot, is applied to the medium and at least one light beam is directed onto the marker or coloured dot and the distance between a nozzle of the ink jet printer and the top face of the medium directed towards it and the ink jet printer or print head and/or nozzle is detected on the basis of the light reflected by this coloured dot.

82. Method as claimed in one of claims 70 to 81, characterised in that in order to form a continuous hanging loop of the medium, the medium is fed forwards in the direction of a guide surface of the medium used to apply the ink until a distance perpendicular to the guide surface of the medium corresponds to a dimension of the subsequent intermittent forward feed motion of the medium across the guide surface, whereupon the medium is held stationary by the side remote from the guide surface and is moved forwards, relative to the guide surface, in the longitudinal direction of the medium by a pre-settable length of the distance of the loop.
